(19) United States
(12) Patent Application Publication
(10) Pub. No.: US 2019/0177632 A1
(43) Pub. Date: Jun. 13, 2019

(54) FUEL COMPOSITIONS CONTAINING DETERGENTS DERIVED FROM ETHYLENE-ALPHA OLEFIN COPOLYMERS

(71) Applicant: AFTON CHEMICAL CORPORATION, Richmond, VA (US)

(72) Inventors: Nathaniel Cain, Richmond, VA (US); Michel Nuckols, Midlothian, VA (US); John Loper, Henrico, VA (US); Lawrence Cunningham, Mechanicsville, VA (US); William Colucci, Glen Allen, VA (US)

(73) Assignee: AFTON CHEMICAL CORPORATION, Richmond, VA (US)

(21) Appl. No.: 16/006,401

(22) Filed: Jun. 12, 2018

(30) Foreign Application Priority Data
Dec. 12, 2017 (US) PCT/US2017/065767

(51) Int. Cl. C10L 10/04; C10L 10/06; C10L 1/236; F02M 65/00

(52) U.S. Cl. CPC C10L 10/04; C10L 10/06; C10L 1/236; C10L 2270/026; C10L 2200/0259; C10L 2250/04; C10L 2270/023; F02M 65/008

(57) ABSTRACT

A fuel composition including a fuel and a fuel additive including a fuel soluble detergent selected from succinimide compounds of the Formula (I), Mannich detergents of the formulae (IIa), and amine detergents of the formulae (IIIa) and (IIIb). The fuel soluble detergents are derived from a specific class of ethylene-alpha olefin copolymers having an Mn of less than 5,000 g/mol, an ethylene unit content of more than 40 mol % to less than 90 mol %; a terminal unsaturation of 70 mol % or greater; at least 70 mol % of the unsaturation is terminal vinylidene, one or more tri-substituted isomers of the terminal vinylidene or any combination thereof, an average ethylene run length of less than 2.6; and wherein n_{C2,Actual}>n_{C2,Statistical}. Methods employing the fuel compositions for operating diesel and gasoline engines to reduce injector valve deposits, valve sticking and injector nozzle fouling, and a method for stabilizing a diesel fuel composition.

### TECHNICAL FIELD

The disclosure is directed to fuel compositions that include a detergent additive useful in fuels. The detergent may be used for stabilizing a diesel fuel composition or a gasoline fuel composition. Also, the fuel compositions of the disclosure may be employed to reduce injector nozzle fouling in a diesel internal combustion engine, reduce injector valve deposits in a gasoline internal combustion engine, and/or reduce valve sticking in a gasoline internal combustion engine. In particular the disclosure is directed to fuels containing detergents derived from ethylene-alpha olefin copolymers.

### BACKGROUND OF THE INVENTION

Fuel compositions for vehicles are continually being improved to enhance various properties of the fuels in order to accommodate their use in newer, more advanced engines. Accordingly, the fuel compositions contain additives which are directed to certain properties that require improvement. For example, friction modifiers, such as fatty acid amides, are added to fuel to reduce friction and wear in the fuel delivery systems of an engine. Other additives are included in the fuel compositions to reduce the corrosion potential of the fuel composition and/or improve the conductivity property of the fuel composition. Still other additives are added to the fuel to improve the fuel economy of an engine operating on the fuel. Each of the foregoing additives may be effective to improve a single property of the fuel composition and, in some instances, may adversely affect other properties of the fuel composition. Accordingly, fuel compositions typically include a complex mixture of additives that are selected to cooperate with each other to improve the fuel composition. Some of the additives may be beneficial for one characteristic, but detrimental to another characteristic of the fuel. Accordingly, there is a need for a fuel additive that is effective to improve multiple characteristics of a fuel.

Engine and fuel delivery system deposit is a particularly important problem for modern combustion engines and deposit control additives are used to mitigate this problem. For example, diesel engines suffer from deposits in the fuel delivery system. Well known succinimide type detergents offer limited detergency as measured by industry DW10 and XUD9 tests.

Gasoline engines also have problems with deposits, particularly in the valves. Common detergents such as Mannich detergents, may not provide sufficient cleaning power to control these deposits.

Quaternary ammonium compounds such as alkoxylated salts have recently been developed as detergents and examples of such quaternary ammonium compounds are known as is disclosed in U.S. Pat. No. 8,147,569.

Quaternary ammonium compounds made by alkylation with dialkyl carbonate are disclosed in U.S. Pat. No. 8,147,569. However the carbonate anion part of the molecule is susceptible to precipitation and drop out in fuels or additive packages. In addition, the detergency of quaternary ammonium carbonates may still need to be improved.

Additives of the disclosure may overcome the deficiencies of current known fuel detergents by providing improved detergency and reduced negative impact on diesel fuel stability.

### SUMMARY OF THE INVENTION

In accordance with the disclosure, exemplary embodiments provide fuel compositions, a method of stabilizing a diesel fuel composition, and to methods of reducing injector nozzle fouling in a diesel internal combustion engine, reducing injector valve deposits in a gasoline internal combustion engine, and/or reducing valve sticking in a gasoline internal combustion engine. In particular the disclosure is directed to fuels containing detergents derived from ethylene-alpha olefin copolymers.

In one embodiment, the disclosure relates to a fuel composition including a fuel and a fuel additive. The fuel additive comprises a fuel soluble detergent selected from compounds of the Formulae (I), (IIa), (IIIa) and (IIIb):

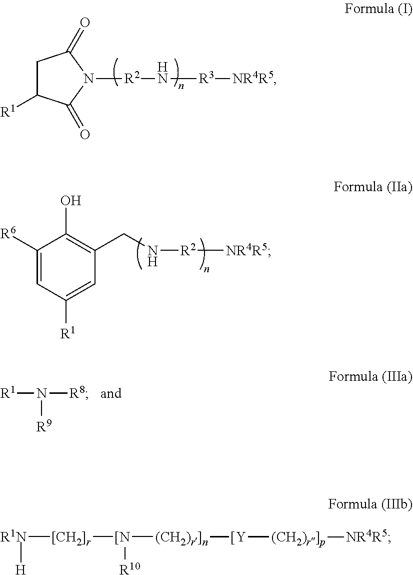

wherein n and p can be the same or different and each of n and p independently is 0, 1, 2, 3, 4, 5, 6, 7, or 8; r, r′, and r″ can be the same or different and each of r, r′, and r″ independently is an integer of from 2 to 6; Y is O or NR¹⁰; R¹ is an hydrocarbyl radical derived from a copolymer of ethylene and one or more C₃₋₁₀ alpha-olefins;

the copolymer has a number average molecular weight of less than 5,000 g/mol as measured by GPC using polystyrene as a calibration reference;

the ethylene unit content of the copolymer measured by ¹H-NMR spectroscopy is greater than 40 mol % and less than 90 mol %;

the copolymer has a terminal unsaturation of 70 mol % or greater as measured by ¹³C NMR spectroscopy; and

at least 70 mol % of the terminal unsaturation is terminal vinylidene, one or more tri-substituted isomers of the terminal vinylidene or any combination thereof, as measured by ¹H-NMR spectroscopy;

the copolymer has an average ethylene run length n_{C2,Actual}, as measured by ¹³C NMR spectroscopy, of less than 2.6; and wherein:

n_{C2,Actual}>n_{C2,Statistical};

R² and R³ are each independently selected from a divalent C₁-C₆ alkylene; each of R⁴ and R⁵,
independently, is H, C₁-C₆ alkyl,

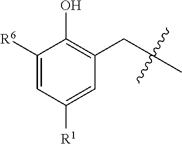

or, together with the N to which they are attached to, form a 5 or 6-membered ring optionally fused with a non-aromatic or an aromatic ring having the following formula

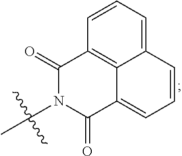 [SMILES: *N1C(=O)c2cccc3cccc(c23)C1=O]

R⁶ is H or C₁-C₆ alkyl, or —CH₂—(NH—R²)ₙ—NR⁴R⁵, or R⁶ may be the same as R¹ or if R¹ and R⁶ are not the same, the positions of R¹ and R⁶ may be switched; R⁷, R⁸, R⁹ and R¹⁰ are independently selected from the group consisting of hydrogen, C₁ to C₂₅ straight or branched chain alkyl groups; C₂ to C₁₂ alkoxy C₂ to C₆ alkylene groups; C₂ to C₁₂ hydroxy amino alkylene groups; and C₁ to C₁₂ alkylamino C₂ to C₆ alkylene groups; and wherein R¹⁰ can additionally comprise a group of the formula:

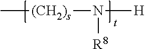

wherein R⁸ is as defined above and wherein s is an integer of from 2 to 6 and t is an integer from 0 to 10.

The fuel composition may contain greater than 50 wt. % of fuel and a detergent derived from an ethylene-alpha olefin copolymer.

In each of the foregoing embodiments, the fuel soluble detergent may be present in the fuel composition in a range of from 10 to 500 ppmw (2.5 to 132 ptb) of the fuel soluble detergent, or from 20 to 300 ppmw (5 to 85 ptb) of the fuel soluble detergent or from 40 to 200 ppmw (10 to 56 ptb) or 50 to 150 ppmw (12.5 to 40 ptb) of the fuel soluble detergent or, the fuel composition may contain from 10 to 500 ptb of the fuel soluble detergent.

In each of the foregoing embodiments, n may be from 3-6.

In each of the foregoing embodiments, the detergent may be a detergent of the Formula (I). In this embodiment, the detergent is a reaction product prepared by reaction of ethylene-propylene copolymer-substituted succinic anhydride, which is obtained by reacting an ethylene-propylene copolymer with maleic anhydride, with an amine-containing compound, and wherein the molar ratio of the maleic anhydride and the copolymer is 1:1 to 2:1; and the molar ratio of the copolymer-substituted succinic anhydride to the amine-containing compound is from 1:1 to 3:1, 1.2:1 to 2:1, and preferably about 1.5:1.

In each of the foregoing embodiments, the detergent may be a detergent of the formulae (IIa) and (IIb). In such embodiments, the detergent may be selected from one of the following structures:

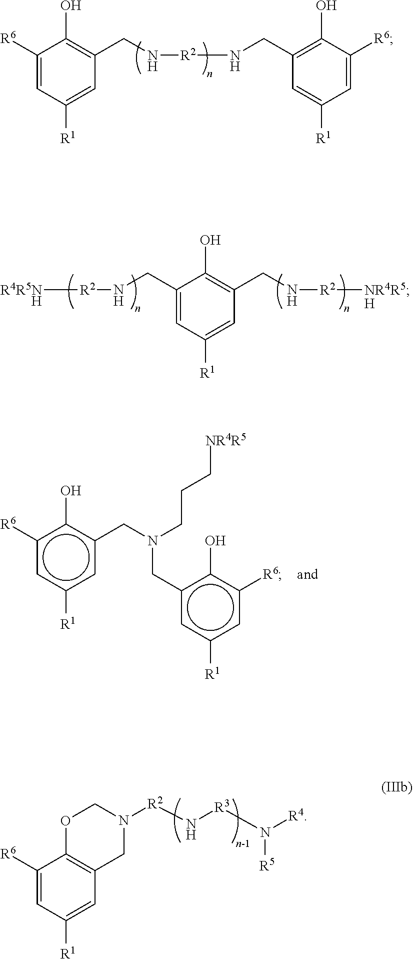

In each of the foregoing embodiments, the detergent may be a detergent of the formulae (IIIa) and (IIIb).

In each of the foregoing embodiments, the detergent may be derived from an amine of the formula:

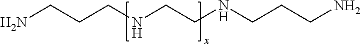

wherein x is an integer of from 0 to 3, an amine of the formula:

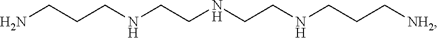 [SMILES: NCCCNCCNCCNCCCN]

a polyoxyalkylene polyamine such as those of the Formula (IX):

NH₂-alkylenetO-alkyleneₘNH₂ Formula (IX)

where m has a value of about 1 to 30 and preferably 1 to 5, e.g., m is 1; and an amine of the Formula (X):

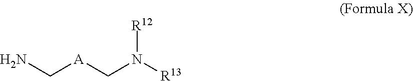

wherein A is a bond or a hydrocarbyl linker with 1 to 10 carbon units and including one or more carbon units thereof independently replaced with a bivalent moiety selected from the group consisting of —O—, —N(R¹⁴)—, —C(O)—, —C(O)O—, —C(O)NR¹⁴; R¹² and R¹³ are independently alkyl groups containing 1 to 8 carbon atoms; and R¹⁴ is independently a hydrogen or a group selected from C₁₋₆ aliphatic, phenyl, or alkylphenyl.

In another embodiment, the disclosure relates to a fuel composition including a fuel and a fuel soluble detergent derived from a copolymer of ethylene and one or more C₃₋₁₀ alpha-olefins described herein, e.g., an ethylene-propylene copolymer. The detergent can be a reaction product prepared by reaction of an ethylene-propylene copolymer-substituted succinic anhydride, which is obtained by reacting a copolymer as described below with unsaturated polycarboxylic acid or anhydride (e.g., maleic anhydride), with an amine compound. The molar ratio of the maleic anhydride to the copolymer can be from 1:1 to 2:1; and the molar ratio of the copolymer-substituted succinic anhydride to the amine compound can be from 1:1 to 3:1, 1.2:1 to 2:1, and preferably about 1.5:1.

The detergent can also be a reaction product of a Mannich product prepared by reacting a hydroxyaromatic compound, e.g., phenol or cresol, with a copolymer as described below and reacting the obtained copolymer-substituted hydroxyaromatic compound with an aldehyde (e.g., formaldehyde) and an amine compound. Suitable amine compounds are described above. The molar ratio of the copolymer-substituted hydroxyaromatic compound:amine:aldehyde can be 1:0.1-10:0.1-10, preferably 1.0:0.5-2.0:1.0-3.0.

Alternatively, the detergent can be a reaction product prepared by (1) hydroformylating a copolymer as described below to form a copolymer having a terminal aldehyde moiety; and (2) reacting the copolymer prepared by the hydroformylating step (1) with an amine compound as described above or ammonium under reducing conditions, e.g., hydrogenation conditions. The molar ratio of copolymer to amine or ammonium may be from 3:1 to 1:3, preferably from 2:1 to 1:2, or 1:1.

In each of the foregoing embodiments, the fuel composition may further include one or more additional fuel additives selected from friction modifiers, detergents, cloud point depressants, pour point depressants, demulsifiers, flow improvers, antistatic agents, other detergents, antioxidants, antifoams, corrosion/rust inhibitors, extreme pressure/antiwear agents, seal swell agents, lubricity agent, antimisting agents, and mixtures thereof, and wherein at least one fuel additive is controlled released over time into a fuel when the gel is in contact with the fuel. In each of the foregoing embodiments, the additional fuel additive may be a friction modifier and/or a lubricity agent.

In each of the foregoing embodiments, the copolymer may have a crossover temperature of −25° C. or lower, or a crossover temperature of −35° C. or lower.

In each of the foregoing embodiments, the ethylene unit content may be from 45 mol % to 87 mol %.

In each of the foregoing embodiments, at least 85 mol % of the terminal unsaturation may be the terminal vinylidene, one or more of the tri-substituted isomers of the terminal vinylidene and any combination thereof, or at least 95 mol % of the terminal unsaturation may be the vinylidene, one or more of the tri-substituted isomers of the terminal vinylidene and any combination thereof.

In each of the foregoing embodiments, the copolymer may have an average ethylene run length of less than 2.4, or an average ethylene run length of less than 2.2.

In each of the foregoing embodiments, the copolymer may have a polydispersity index of less than or equal to 4, or a polydispersity index of less than or equal to 3.

In each of the foregoing embodiments, the number average molecular weight of the copolymer may be less than 3,500 g/mol, or the number average molecular weight of the copolymer is less than 2,500 g/mol, or the number average molecular weight of the copolymer is less than 1,500 g/mol, or the number average molecular weight of the copolymer is from 1,000 to, 2,000 g/mol, all as measured by GPC.

In each of the foregoing embodiments, the terminal vinylidene and the tri-substituted isomers of the terminal vinylidene of the copolymer may have one or more of the following structural Formulas (IV)-(VI):

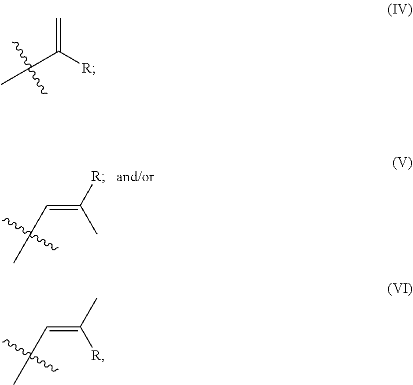

wherein R represents a C₁-C₈ alkyl group and “ [symbol] ” indicates the bond is attached to the remaining portion of the copolymer.

In each of the foregoing embodiments, the copolymer may have a total Zr, Ti, Al and Bcontent of 25 ppmw or less, 10 ppmw or less, 5 ppmw or less, or 1 ppmw or less, based on the total weight of the copolymer, wherein the Zr, Ti, Al, and B is derived from a single-site catalyst and an optional co-catalyst.

In each of the foregoing embodiments, the copolymer may have a fluorine content of less than 10 ppmw, less than 8 ppm, or less than 5 ppmw, based on the total weight of the copolymer.

In each of the foregoing embodiments, the fuel may be a diesel fuel or the fuel may be a gasoline fuel.

In another embodiment is disclosed a method for operating an internal combustion engine by combusting the fuel composition of claim 1 in the internal combustion engine during the engine's operation. In this method, the engine may be a diesel engine and the fuel composition may be a diesel fuel composition. Alternatively, in this method, the engine may be a gasoline engine and the fuel composition may be a gasoline fuel composition.

Another embodiment provides method for reducing injector valve deposits in a gasoline internal combustion engine by combusting a gasoline fuel composition of any of the foregoing embodiments of gasoline fuel compositions in the gasoline internal combustion engine during the engine's operation.

Another embodiment involves a method for reducing valve sticking in a gasoline internal combustion engine by combusting a gasoline fuel composition of any of the foregoing embodiments of gasoline fuel compositions in the gasoline internal combustion engine during the engine's operation. In each of the two previous embodiments, the gasoline engine may be a direct injected gasoline engine.

Still another embodiment provides a method for stabilizing a diesel fuel composition by combining with said diesel fuel composition an additive composition including the fuel additive of any of the foregoing embodiments of fuel additives.

Still another embodiment provides a method for reducing injector nozzle fouling in a diesel internal combustion engine by combusting the diesel fuel composition of any of the foregoing embodiments of diesel fuel compositions in the diesel internal combustion engine during the engine's operation.

Also disclosed is use of any of the gasoline fuel additives described above for reducing injector valve deposits in a gasoline internal combustion engine.

Also disclosed is use of any of the gasoline fuel additives described above for reducing valve sticking in a gasoline internal combustion engine.

In each of the two previous uses, the gasoline engine may be a direct injected engine.

Also disclosed is use of any of the diesel fuel additives described above for stabilizing a diesel fuel composition comprising diesel fuel.

Also disclosed is use of any of the diesel fuel additives described above for stabilizing a injector nozzle clogging in a diesel internal combustion engine.

In another aspect, the present invention is generally directed to a detergent for a fuel prepared by a process comprising: functionalizing a copolymer derived from ethylene and one or more C₃-C₁₀ alpha-olefins, wherein the copolymer has a number average molecular weight of less than 5,000 g/mol as measured by GPC using polystyrene as a calibration reference; wherein the ethylene unit content of the copolymer is less than 80 mol %, as measured by ¹H-NMR spectroscopy; wherein the copolymer has a terminal unsaturation of 70 mol % or greater, as measured by ¹³C NMR spectroscopy, and at least 70 mol % of unsaturation is terminal vinylidene and/or a tri-substituted isomer of the terminal vinylidene, as measured by ¹H-NMR spectroscopy; and wherein the copolymer has an average ethylene run length n_{C2,Actual}, as determined by ¹³C NMR spectroscopy, of less than 2.6, and wherein:

n_{C2,Actual}>n_{C2,Statistical}

In a further aspect, the present invention is generally directed to a copolymer derived from ethylene and one or more C₃-C₁₀ alpha-olefins, wherein the copolymer has a number average molecular weight of less than 5,000 g/mol as measured by GPC; wherein the ethylene unit content of the copolymer is less than 80 mol %; wherein at least 70 mol % of the copolymer has a carbon-carbon double bond in a terminal monomer unit, and at least 70 mol % of the terminal monomer units that have a carbon-carbon double bond are terminal vinylidene and/or a tri-substituted isomer of the terminal vinylidene; and wherein the copolymer has a crossover temperature of −20° C. or lower.

In yet another aspect, the present invention is generally directed to a fuel composition, comprising a derivatized copolymer of the following formula (III):

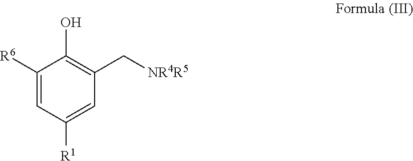

wherein R¹ is an hydrocarbyl radical derived from the copolymer of claim 1, each of R⁴ and R⁵, independently, is H, C₁-C₆ alkyl, or, together with the N to which they are attached to, form a 5 or 6-membered ring optionally fused with an aromatic or non-aromatic ring; and R⁶ is H or C₁-C₆ alkyl.

In a still further aspect, the present invention is generally directed to a method, comprising reacting ethylene and a C₃-C₁₀ alpha-olefin using a coordination polymerization catalyst to produce a copolymer comprising ethylene-derived units and C₃-C₁₀ alpha-olefin-derived units, wherein the alpha-olefin-derived units have a carbon number from three to ten; wherein the copolymer has a number average molecular weight of less than 5,000 g/mol; wherein at least 70 mol % of the copolymer has a terminal monomer unit that is terminal vinylidene and/or a tri-substituted isomer of the terminal vinylidene; wherein the copolymer has an average ethylene-derived unit run length of less than 3, as determined through NMR spectroscopy; wherein less than 80% of a total number of units in the copolymer are ethylene-derived units; and wherein the copolymer has a crossover temperature of −20° C. or lower.

Additives described herein can be used as detergents in fuels. Choice and design of detergent may contribute toward an improved performance. In various embodiments, the detergents described herein may provide one or more of the following advantages: superior dispersancy and/or viscosity, fuel economy, and/or low temperature performance.

In addition, the detergents (also sometimes referred to as “dispersants”) described in the fourth aspect may also be used in fuels, including but not limited to gasoline, biodiesel or diesel, as deposit control additives (also known as fuel detergents) to keep the fuel injectors clean or clean up fouled injectors for spark and compression type engines.

Following are sentences describing additional embodiments of the invention.

1. A detergent prepared by a process comprising: functionalizing a copolymer derived from ethylene and one or more C₃₋₁₀ alpha-olefins, wherein the copolymer has a number average molecular weight of less than 5,000 g/mol as measured by GPC using polystyrene as a calibration reference; wherein an ethylene unit content of the copolymer is less than 80 mol %, as measured by ¹H-NMR spectroscopy; wherein the copolymer has a terminal unsaturation of 70 mol % or greater, as measured by ¹³C-NMR spectroscopy, and at least 70 mol % of the unsaturation is terminal vinylidene, a tri-substituted isomer of a terminal vinylidene or any combination thereof, as measured by ¹H-NMR spectroscopy; and wherein the copolymer has an average ethylene run length a n_{C2,Actual}, as determined by ¹³C NMR spectroscopy, of less than 2.6, and wherein:

n_{C2,Actual}>n_{C2,Statistical}

2. A dispersant prepared by a process comprising: functionalizing a copolymer derived from ethylene and one or more C₃₋₁₀ alpha-olefins, wherein the copolymer has a number average molecular weight of less than 5,000 g/mol as measured by GPC; wherein the ethylene content of the copolymer is less than 80 mol %; wherein 70 mol % or greater of the copolymer has a carbon-carbon double bond in a terminal monomer unit, and at least 70 mol % of the terminal monomer units that have a carbon-carbon double bond have a terminal group selected from a vinylidene group and a tri-substituted isomer of a vinylidene group; and wherein the copolymer has an average ethylene run length n_{c2}, as determined by ¹³C NMR spectroscopy, of less than 2.6, the average ethylene-derived unit run length n_{c2} is defined as the total number of ethylene-derived units in the copolymer divided by a number of runs of one or more sequential ethylene-derived units in the copolymer, and the average ethylene-derived unit run length n_{c2} and also satisfies the relationship shown by the expression below:

$${n}_{C 2} < \frac{( EEE + EEA + AEA )}{( AEA + 0.5 EEA )}$$

$$wherein \text{:}$$

$$EEE = {( {x}_{C 2} )}^{3} , \\ EEA = 2 {( {x}_{C 2} )}^{2} ( 1 - {x}_{C 2} ) , \\ AEA = {{x}_{C 2} ( 1 - {x}_{C 2} )}^{2} ,$$

x_{C2} being the mole fraction of ethylene incorporated in the copolymer as measured by ¹H-NMR spectroscopy, E representing an ethylene monomer moiety, and A representing an alpha olefin monomer moiety.

3. The detergent of sentence 1 or 2, wherein the copolymer has a crossover temperature at −25° C. or lower, or −35° C. or lower.

4. The detergent of any preceding sentence, wherein the copolymer has a crossover temperature at −40° C. or lower.

5. The detergent of any preceding sentence, wherein the ethylene unit content is less than 60 mol %.

6. The detergent of any preceding sentence, wherein the ethylene unit content is less than 50 mol %.

7. The detergent of any preceding sentence, wherein the ethylene unit content is at least 10% and less than 80%.

8. The detergent of any preceding sentence, wherein at least 85 mol % of terminal unsaturation is terminal vinylidene, one or more of the tri-substituted isomers of the terminal vinylidene or any combination thereof.

9. The detergent of any preceding sentence, wherein at least 95 mol % of the terminal unsaturation is selected from the terminal vinylidene, one or more of the tri-substituted isomers of the terminal vinylidene and any combination thereof.

10. The dispersant of sentences 1-8, wherein at least 95 mol % of the terminal monomer units that have the carbon-carbon double bond have a terminal group selected from the vinylidene group and the tri-substituted isomer of the vinylidene group.

11. The detergent of any preceding sentence, wherein the copolymer has an average ethylene run length of less than 2.4.

12. The detergent of any preceding sentence, wherein the copolymer has an average ethylene run length of less than 2.2.

13. The detergent of any preceding sentence, wherein the copolymer has a polydispersity index of less than or equal to 4.

14. The detergent of any preceding sentence, wherein the copolymer has a polydispersity index of less than or equal to 3.

15. The detergent of any preceding sentence, wherein the copolymer is an ethylene-propylene copolymer, wherein the ethylene unit content is 30 to less than 80 mol % and a propylene unit content is 20-70 mol %.

16. The detergent of any preceding sentence, wherein the copolymer is an ethylene-propylene copolymer, wherein the ethylene unit content is 40-60 mol % and the propylene unit content is 40-60 mol %.

17. The detergent of any preceding sentence, wherein the copolymer is an ethylene-propylene copolymer, wherein the ethylene unit content is about 40-50 mol % and the propylene unit content is about 50-60 mol %.

18. The detergent of any preceding sentence, wherein the number average molecular weight of the copolymer is less than 3,500 g/mol, as measured by GPC.

19. The detergent of any preceding sentence, wherein the number average molecular weight of the copolymer is greater than 500 and less than 3,000 g/mol, as measured by GPC.

20. The detergent of any preceding sentence, wherein the detergent has one of the following formulas:

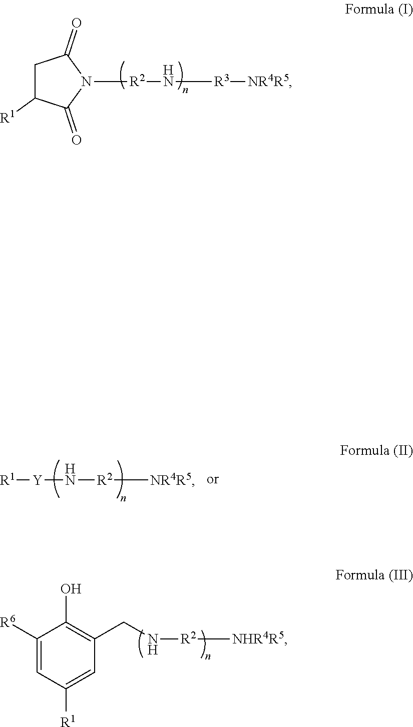

wherein R¹ is an hydrocarbyl radical derived from the copolymer; R² is a divalent C₁-C₆ alkylene; R³ is a divalent C₁-C₆ alkylene; each of R⁴ and R⁵, independently, is H, C₁-C₆ alkyl,

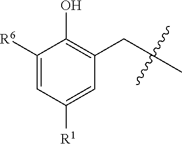

or, together with the N to which they are attached to, form a 5 or 6-membered ring optionally fused with an aromatic or non-aromatic ring; R⁶ is H or C₁-C₆ alkyl, or —CH₂—(NH—R²)ₙ—NR⁴R⁵; Y is a covalent bond or C(O); and n is 0, 1, 2, 3, 4, 5, 6, 7, or 8.

21. The detergent of any preceding sentence, wherein the terminal vinylidene and the tri-substituted isomers of the terminal vinylidene of the copolymer have one or more of the following structural formulas (IV)-(VI):

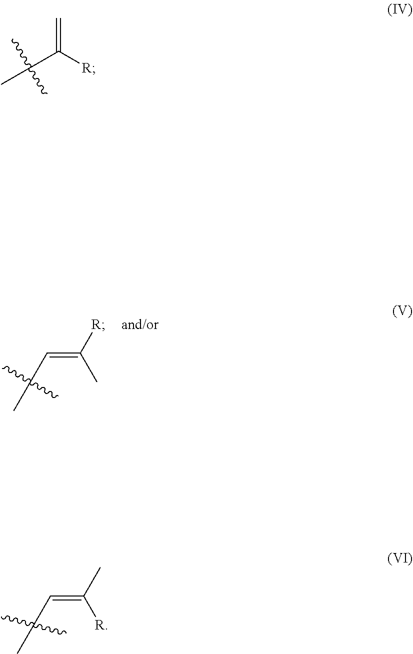

wherein R represents a C₁-C₈ alkyl group and “ [symbol] ” indicates the bond is attached to the remaining portion of the copolymer.

22. A fuel composition or fuel additive composition, comprising the detergent of sentence 20 or 21.

23. A copolymer derived from ethylene and one or more C₃₋₁₀ alpha-olefins, wherein the copolymer has a number average molecular weight of less than 5,000 g/mol as measured by GPC; wherein the ethylene unit content of the copolymer is less than 80 mol %; wherein 70 mol % or greater of the copolymer has a carbon-carbon double bond in a terminal monomer unit, and at least 70 mol % of the terminal monomer units that have a carbon-carbon double bond have a terminal vinylidene, one or more of the tri-substituted isomers of the terminal vinylidene and any combination thereof; and wherein a storage modulus of the copolymer is equal to a loss modulus of the copolymer at a temperature of −30° C. or lower, the values of the storage modulus and the loss modulus of the copolymer being determined by oscillatory rheometry.

24. A copolymer derived from ethylene and one or more C₃₋₁₀ alpha-olefins, wherein the copolymer has a number average molecular weight of less than 5,000 g/mol as measured by GPC; wherein the ethylene content of the copolymer is less than 80 mol %; wherein 70 mol % or greater of the copolymer has a carbon-carbon double bond in a terminal monomer unit, and at least 70 mol % of the terminal monomer units that have a carbon-carbon double bond have a terminal group selected from a vinylidene group and a tri-substituted isomer of a vinylidene group; and wherein a storage modulus of the copolymer is equal to a loss modulus of the copolymer at a temperature of −30° C. or lower, the values of the storage modulus and the loss modulus of the copolymer being determined by oscillatory rheometry.

25. The copolymer of sentence 23 or 24, wherein the terminal vinylidene and the tri-substituted isomers of terminal vinylidene of the copolymer have one or more of the following structural formulas (IV)-(VI):

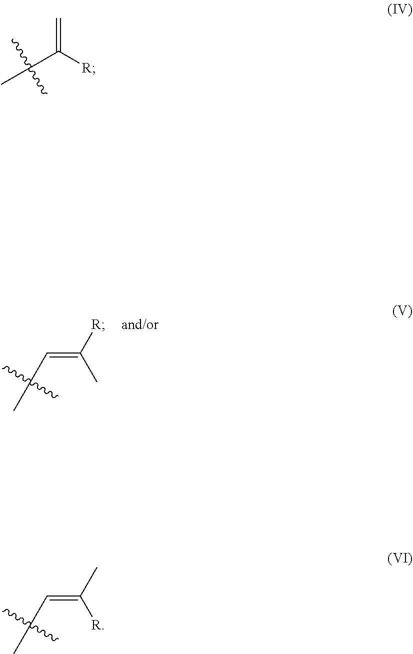

wherein R represents a C₁-C₈ alkyl group and “ [symbol] ” indicates the bond is attached to the remaining portion of the copolymer.

26. The copolymer of sentence 25, wherein the copolymer has an average ethylene run length (n_{C2}) of less than 2.6, as determined by ¹³C NMR spectroscopy.

27. The copolymer of sentence 26, wherein the copolymer has an average ethylene run length (n_{C2}) satisfying the relationship shown by the expression below:

$${n}_{C 2} < \frac{( EEE + EEA + AEA )}{( AEA + 0.5 EEA )}$$

$$wherein \text{:}$$

$$EEE = {( {x}_{C 2} )}^{3} , \\ EEA = 2 {( {x}_{C 2} )}^{2} ( 1 - {x}_{C 2} ) , \\ AEA = {{x}_{C 2} ( 1 - {x}_{C 2} )}^{2} ,$$

x_{C2} being the mole fraction of ethylene incorporated in the copolymer as measured by ¹H-NMR spectroscopy, E representing an ethylene monomer moiety, and A representing an alpha olefin monomer moiety.

28. The copolymer of sentence 26, wherein

n_{C2,Actual}>n_{C2,Statistical}

29. The copolymer of any one of sentences 23-28, wherein the copolymer has a crossover temperature of −20° C. or lower.

30. The copolymer of any one of sentences 23-29, wherein the ethylene unit content is less than 70 mol %.

31. The copolymer of any one of sentences 23-29, wherein less than 65% of the total number of units in the copolymer are ethylene-derived units.

32. The copolymer of any one of sentences 23-29, wherein less than 60% of the total number of units in the copolymer are ethylene-derived units.

33. The copolymer of any one of sentences 23-29, wherein less than 55% of the total number of units in the copolymer are ethylene-derived units.

34. The copolymer of any one of sentences 23-29, wherein less than 50% of the total number of units in the copolymer are ethylene-derived units.

35. The copolymer of any one of sentences 28-29, wherein less than 45% of the total number of units in the copolymer are ethylene-derived units.

36. The copolymer of any one of sentences 23-29, wherein less than 40% of the total number of units in the copolymer are ethylene-derived units.

37. The copolymer of any one of sentences 23-29, wherein at least 10% and less than 80% of the total number of units in the copolymer are ethylene-derived units.

38. The copolymer of any one of sentences 23-29, wherein at least 20% and less than 70% of the total number of units in the copolymer are ethylene-derived units.

39. The copolymer of any one of sentences 23-29, wherein at least 30% and less than 65% of the total number of units in the copolymer are ethylene-derived units.

40. The copolymer of any one of sentences 23-29, wherein at least 40% and less than 60% of the total number of units in the copolymer are ethylene-derived units.

41. The copolymer of any one of sentences 23-40, wherein at least 20% of the total number of units in the copolymer are C₃-C₁₀ alpha-olefin-derived units.

42. The copolymer of any one of sentences 23-40, wherein at least 30% of the total number of units in the copolymer are C₃-C₁₀ alpha-olefin-derived units.

43. The copolymer of any one of sentences 23-40, wherein at least 35% of the total number of units in the copolymer are C₃-C₁₀ alpha-olefin-derived units.

44. The copolymer of any one of sentences 23-40, wherein at least 40% of the total number of units in the copolymer are C₃-C₁₀ alpha-olefin-derived units.

45. The copolymer of any one of sentences 23-40, wherein at least 45% of the total number of units in the copolymer are C₃-C₁₀ alpha-olefin-derived units.

46. The copolymer of any one of sentences 23-40, wherein at least 50% of the total number of units in the copolymer are C₃-C₁₀ alpha-olefin-derived units.

47. The copolymer of any one of sentences 23-40, wherein at least 55% of the total number of units in the copolymer are C₃-C₁₀ alpha-olefin-derived units.

48. The copolymer of any one of sentences 23-40, wherein at least 60% of the total number of units in the copolymer are C₃-C₁₀ alpha-olefin-derived units.

49. The copolymer of any one of sentences 23-48, wherein at least 75 mol % of the terminal monomer units that have the carbon-carbon double bond have a terminal unsaturation selected from the terminal vinylidene, one or more of the tri-substituted isomers of the terminal vinylidene and any combination thereof.

50. The copolymer of any one of sentences 23-48, wherein at least 75 mol % of the terminal monomer units that have the carbon-carbon double bond have a terminal group selected from the vinylidene group and the tri-substituted isomer of the vinylidene group.

51. The copolymer of any one of sentences 23-48, wherein at least 80 mol % of the terminal monomer units that have the carbon-carbon double bond have a terminal unsaturation selected from the terminal vinylidene, one or more of the tri-substituted isomers of the terminal vinylidene and any combination thereof.

52. The copolymer of any one of sentences 23-48, wherein at least 85 mol % of the terminal monomer units that have the carbon-carbon double bond have a terminal unsaturation selected from the terminal vinylidene, one or more of the tri-substituted isomers of the terminal vinylidene and any combination thereof.

53. The copolymer of any one of sentences 23-48, wherein at least 90 mol % of the terminal monomer units that have the carbon-carbon double bond have a terminal unsaturation selected from the terminal vinylidene, one or more of the tri-substituted isomers of the terminal vinylidene and any combination thereof.

54. The copolymer of any one of sentences 23-48, wherein at least 95 mol % of the terminal monomer units that have the carbon-carbon double bond have a terminal unsaturation selected from the terminal vinylidene, one or more of the tri-substituted isomers of the terminal vinylidene and any combination thereof.

55. The copolymer of any one of sentences 23-48, wherein at least 80 mol % of the terminal monomer units that have the carbon-carbon double bond have a terminal group selected from the vinylidene group and the tri-substituted isomer of the vinylidene group.

56. The copolymer of any one of sentences 23-48, wherein at least 85 mol % of the terminal monomer units that have the carbon-carbon double bond have a terminal group selected from the vinylidene group and the tri-substituted isomer of the vinylidene group.

57. The copolymer of any one of sentences 23-48, wherein at least 90 mol % of the terminal monomer units that have the carbon-carbon double bond have a terminal group selected from the vinylidene group and the tri-substituted isomer of the vinylidene group.

58. The copolymer of any one of sentences 23-48, wherein at least 95 mol % of the terminal monomer units that have the carbon-carbon double bond have a terminal group selected from the vinylidene group and the tri-substituted isomer of the vinylidene group.

59. The copolymer of any one of sentences 23-58, wherein the copolymer has an average ethylene-derived unit run length of less than 2.8.

60. The copolymer of any one of sentences 23-58, wherein the copolymer has an average ethylene-derived unit run length of less than 2.6.

61. The copolymer of any one of sentences 23-58, wherein the copolymer has an average ethylene-derived unit run length of less than 2.4.

62. The copolymer of any one of sentences 23-58, wherein the copolymer has an average ethylene-derived unit run length of less than 2.2.

63. The copolymer of any one of sentences 23-58, wherein the copolymer has an average ethylene-derived unit run length of less than 2.

64. The copolymer of any one of sentences 23-63, wherein the storage modulus of the copolymer is equal to the loss modulus of the copolymer at a temperature of −25° C. or lower.

65. The copolymer of any one of sentences 23-63, wherein the storage modulus of the copolymer is equal to the loss modulus of the copolymer at a temperature of −30° C. or lower.

66. The copolymer of any one of sentences 23-63, wherein the storage modulus of the copolymer is equal to the loss modulus of the copolymer at a temperature of −35° C. or lower.

67. The copolymer of any one of sentences 23-63, wherein the storage modulus of the copolymer is equal to the loss modulus of the copolymer at a temperature of −40° C. or lower.

68. The copolymer of any one of sentences 23-67, wherein the copolymer has a polydispersity index of less than or equal to 4.

69. The copolymer of any one of sentences 23-67, wherein the copolymer has a polydispersity index of less than or equal to 3.

70. The copolymer of any one of sentences 23-67, wherein the copolymer has a polydispersity index of less than or equal to 2.

71. The copolymer of any one of sentences 2-70, wherein the C₃-C₁₀ alpha-olefin-derived units comprise propylene-derived units.

72. The copolymer of any one of sentences 23-71, wherein the number average molecular weight of the copolymer is less than 5000 g/mol.

73. The copolymer of any one of sentences 23-71, wherein the number average molecular weight of the copolymer is less than 4000 g/mol.

74. The copolymer of any one of sentences 23-71, wherein the number average molecular weight of the copolymer is less than 3000 g/mol.

75. The copolymer of any one of sentences 23-71, wherein the number average molecular weight of the copolymer is less than 2500 g/mol.

76. The copolymer of any one of sentences 23-71, wherein the number average molecular weight of the copolymer is less than 2000 g/mol.

77. The copolymer of any one of sentences 23-71, wherein the number average molecular weight of the copolymer is less than 1500 g/mol.

78. The copolymer of any one of sentences 23-71, wherein the number average molecular weight of the copolymer is less than 1000 g/mol.

79. The copolymer of any one of sentences 23-71, wherein the number average molecular weight of the copolymer is between 800 and 3000 g/mol as measured by GPC.

80. The copolymer of any one of sentences 23-71, having a total metal or ash content of 25 ppmw or less, based on the total weight of the copolymer.

81. The copolymer of sentence 80, wherein the copolymer has a total Zr, Ti, Al and B content of 25 ppmw or less, based on the total weight of the copolymer, wherein the Zr, Ti, Al, and B is derived from a single-site catalyst and an optional co-catalyst.

82. The copolymer of any one of sentences 80-81, wherein the copolymer has a total Zr, Ti, Al, and B content of 10 ppmw or less, or 5 ppmw or less, or 1 ppmw or less, based on the total weight of the copolymer, wherein the Zr, Ti, Al, and B is derived from a single-site catalyst and an optional co-catalyst.

83. The copolymer of any one of sentences 23-82, having a fluorine content of less than 10 ppmw, or less than 8 ppmw, or less than 5 ppmw, based on the total weight of the copolymer.

84. A detergent prepared by functionalizing a copolymer of any one of sentences 23-83.

85. The detergent of sentence 84, wherein the detergent has one of the following formulas:

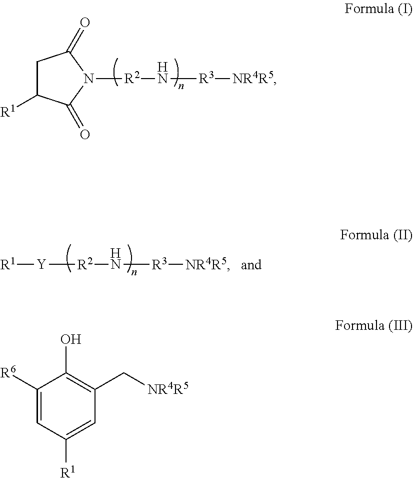

wherein R¹ is an hydrocarbyl radical derived from the copolymer, R² is a divalent C₁-C₆ alkylene, R³ is a divalent C₁-C₆ alkylene, each of R⁴ and R⁵, independently, is H, C₁-C₆ alkyl, or, together with the N to which they are attached to, form a 5 or 6-membered ring optionally fused with an aromatic or non-aromatic ring; R⁶ is H or C₁-C₆ alkyl, Y is a covalent bond or C(O), and n is 0, 1, 2, 3, 4, 5, 6, 7, or 8.

86. A fuel or fuel additive composition, comprising a derivatized copolymer of the following formula:

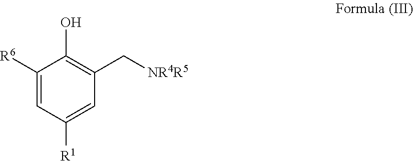

wherein R¹ is an hydrocarbyl radical derived from the copolymer of sentence 1, each of R⁴ and R⁵, independently, is H, C₁-C₆ alkyl, or, together with the N to which they are attached to, form a 5 or 6-membered ring optionally fused with an aromatic or non-aromatic ring; and R⁶ is H or C₁-C₆ alkyl.

87. The detergent of sentence 86, wherein the detergent is prepared by functionalizing the copolymer through one of the following chemical mechanisms: a succinimide-succinimide approach, a Koch-approach, a Mannich-approach, a hydroformylation-reductive-amination approach, or a halogenation-amination approach.

88. A detergent prepared by a process comprising: functionalizing a copolymer derived from ethylene and one or more C₃₋₁₀ alpha-olefins, wherein the copolymer has a number average molecular weight of less than 5,000 g/mol as measured by GPC; wherein the ethylene unit content of the copolymer is less than 80 mol %; wherein 70 mol % or greater of the copolymer has a carbon-carbon double bond in a terminal monomer unit, and at least 70 mol % of the terminal monomer units that have a carbon-carbon double bond have a terminal unsaturation selected from terminal vinylidene, one or more a tri-substituted isomers of the terminal vinylidene and any combination thereof; and wherein the copolymer has an average ethylene run length n_{c2}, as determined by ¹³C NMR spectroscopy, of less than 2.6, the average ethylene-derived unit run length n_{c2} is defined as the total number of ethylene-derived units in the copolymer divided by a number of runs of one or more sequential ethylene-derived units in the copolymer, and the average ethylene-derived unit run length n_{c2} and also satisfies the relationship shown by the expression below:

$${n}_{C 2} < \frac{( EEE + EEA + AEA )}{( AEA + 0.5 EEA )}$$

$$wherein \text{:}$$

$$EEE = {( {x}_{C 2} )}^{3} , \\ EEA = 2 {( {x}_{C 2} )}^{2} ( 1 - {x}_{C 2} ) , \\ AEA = {{x}_{C 2} ( 1 - {x}_{C 2} )}^{2} ,$$

x_{C2} being the mole fraction of ethylene incorporated in the copolymer as measured by ¹H-NMR spectroscopy, E representing an ethylene monomer moiety, and A representing an alpha olefin monomer moiety.

89. A detergent prepared by a process comprising: functionalizing a copolymer derived from ethylene and one or more C₃₋₁₀ alpha-olefins, wherein the copolymer has a number average molecular weight of less than 5,000 g/mol as measured by GPC; wherein the ethylene unit content of the copolymer is less than 80 mol %; wherein 70 mol % or greater of the copolymer has a carbon-carbon double bond in a terminal monomer unit, and at least 70 mol % of the terminal monomer units that have a carbon-carbon double bond have a terminal unsaturation selected from terminal vinylidene, one or more a tri-substituted isomers of the terminal vinylidene and any combination thereof; and wherein the copolymer has an average ethylene run length n_{c2}, as determined by ¹³C NMR spectroscopy, of less than 2.6, the average ethylene-derived unit run length n_{c2} is defined as the total number of ethylene-derived units in the copolymer divided by a number of runs of one or more sequential ethylene-derived units in the copolymer, and the average ethylene-derived unit run length n_{c2} and n_{C2,Actual}>n_{C2,Statistical}.

90. The detergent of any one of sentences 88-89, wherein the terminal vinylidene and the tri-substituted isomers of the terminal vinylidene of the copolymer have one or more of the following structural formulas (IV)-(VI):

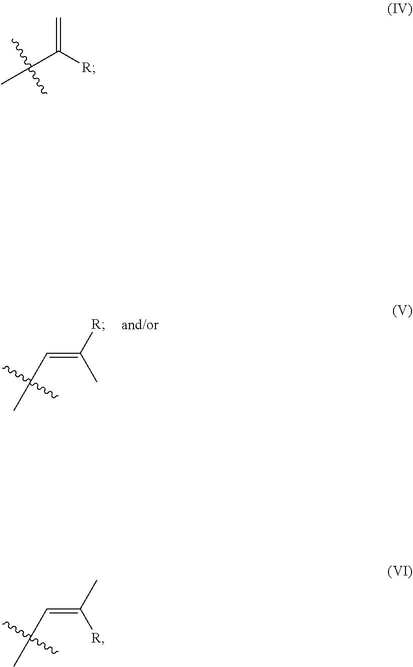

wherein R represents a C₁-C₈ alkyl group and “ [symbol] ” indicates the bond is attached to the remaining portion of the copolymer.

91. The detergent of any one of sentences 88-90, wherein the copolymer has a crossover temperature of −25° C. or lower.

92. The detergent of any one of sentences 88-90, wherein the copolymer has a crossover temperature of −35° C. or lower.

93. The detergent of any one of sentences 88-92, wherein the ethylene unit content is less than 60 mol %.

94. The detergent of any one of sentences 88-92, wherein the ethylene unit content is less than 50 mol %.

95. The detergent of any one of sentences 88-92, wherein at least 10% and less than 80% of the total number of units in the copolymer are ethylene-derived units.

96. The detergent of any one of sentences 88-95, wherein at least 85 mol % of the terminal monomer units that have the carbon-carbon double bond have a terminal unsaturation selected from the terminal vinylidene, one or more of the tri-substituted isomers of the terminal vinylidene and any combination thereof.

97. The detergent of any one of sentences 88-95, wherein at least 85 mol % of the terminal monomer units that have the carbon-carbon double bond have a terminal group selected from the vinylidene group and the tri-substituted isomer of the vinylidene group.

98. The detergent of any one of sentences 88-95, wherein at least 95 mol % of the terminal monomer units that have the carbon-carbon double bond have a terminal group selected from the vinylidene group and the tri-substituted isomer of the vinylidene group.

99. The detergent of any one of sentences 88-95, wherein at least 95 mol % of the terminal monomer units that have the carbon-carbon double bond have a terminal unsaturation selected from the terminal vinylidene, one or more of the tri-substituted isomers of the terminal vinylidene and any combination thereof.

100. The detergent of any one of sentences 88-99, wherein the copolymer has an average ethylene run length of less than 2.4.

101. The detergent of any one of sentences 88-99, wherein the copolymer has an average ethylene run length of less than 2.2.

102. The detergent of any one of sentences 88-101, wherein the copolymer has a polydispersity index of less than or equal to 4.

102. The detergent of any one of sentences 88-104, wherein the copolymer has a polydispersity index of less than or equal to 3.

103. The detergent of any one of sentences 88-105, wherein the copolymer is an ethylene-propylene copolymer, wherein the ethylene unit content is 30-80 mol % and the propylene unit content is 20-70 mol %.

104. The detergent of any one of sentences 88-105, wherein the copolymer is an ethylene-propylene copolymer, wherein the ethylene unit content is 40-60 mol % and the propylene unit content is 40-60 mol %.

105. The detergent of any one of sentences 88-105, wherein the copolymer is an ethylene-propylene copolymer, wherein the ethylene unit content is about 40-50 mol % and the propylene unit content is about 50-60 mol %.

106. The detergent of any one of sentences 88-105, wherein the number average molecular weight of the copolymer is less than 3,500 g/mol, as measured by GPC.

107. The detergent of any one of sentences 88-105, wherein the number average molecular weight of the copolymer is less than 1,500 g/mol, as measured by GPC.

108. The detergent of any one of sentences 88-107, wherein the detergent has one of the following formulas:

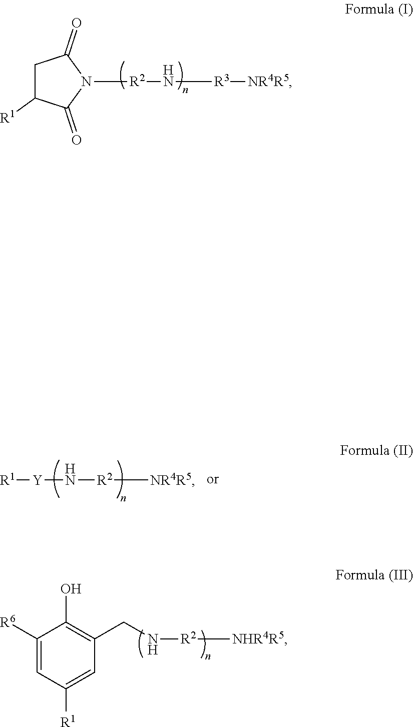

wherein R¹ is an hydrocarbyl radical derived from the copolymer; R² is a divalent C₁-C₆-alkylene; R³ is a divalent C₁-C₆ alkylene; each of R⁴ and R⁵, independently, is H, C₁-C₆ alkyl,

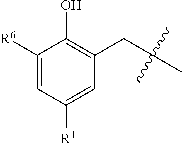

or, together with the N to which they are attached to, form a 5 or 6-membered ring optionally fused with an aromatic or non-aromatic ring; R⁶ is H or C₁-C₆ alkyl, or —CH₂—(NH—R²)ₙ—NR⁴R⁵; Y is a covalent bond or C(O); and n is 0, 1, 2, 3, 4, 5, 6, 7, or 8.

109. The detergent of any one of sentences 88-108, wherein the copolymer has a total metal or ash content of 25 ppmw or less, based on the total weight of the copolymer.

110. The detergent of sentence 109, wherein the total metal or ash content is a total content of Zr, Ti, Al and B, derived from a single-site catalyst and an optional co-catalyst.

111. The detergent of any one of sentences 108 and 109, wherein the copolymer has a total Zr, Ti, Al, and B content of 10 ppmw or less, or 5 ppmw or less, or 1 ppmw or less, based on the total weight of the copolymer, wherein the Zr, Ti, Al, and B is derived from a single-site catalyst and an optional co-catalyst.

112. The detergent of any one of sentences 88-111, having a fluorine content of less than 10 ppmw, or less than 8 ppmw, or less than 5 ppmw, based on the total weight of the copolymer.

113. A fuel composition or fuel additive composition, comprising the detergent of sentence 88-112.

114. The fuel composition or fuel additive composition of sentence 113, the detergent having one of the following formulas:

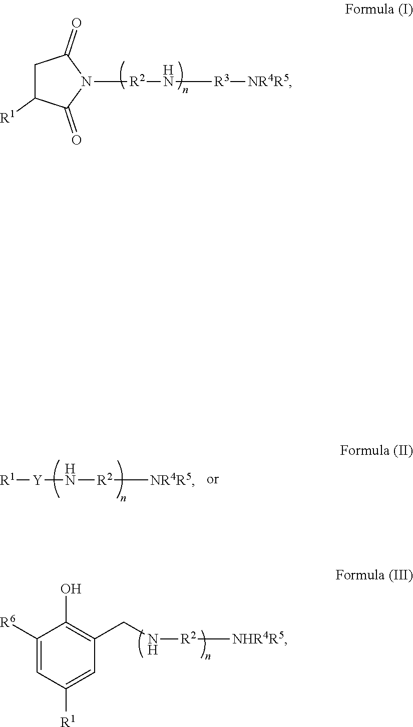

wherein R¹ is an hydrocarbyl radical derived from the copolymer; R² is a divalent C₁-C₆ alkylene; R³ is a divalent C₁-C₆ alkylene; each of R⁴ and R⁵, independently, is H, C₁-C₆ alkyl,

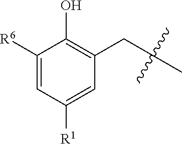

or, together with the N to which they are attached to, form a 5 or 6-membered ring optionally fused with an aromatic or non-aromatic ring; R⁶ is H or C₁-C₆ alkyl, or —CH₂—(NH—R²)ₙ—NR⁴R⁵; Y is a covalent bond or C(O); and n is 0, 1, 2, 3, 4, 5, 6, 7, or 8.

Additional details and advantages of the disclosure will be set forth in part in the description which follows, and/or may be learned by practice of the disclosure. The details and advantages of the disclosure may be realized and attained by means of the elements and combinations particularly pointed out in the appended claims.

### DETAILED DESCRIPTION OF EXEMPLARY EMBODIMENTS

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include: (a) hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form an alicyclic moiety);

(b) substituted hydrocarbon substituents, that is, substituents containing non-hydrocarbon groups which, in the context of this disclosure, do not alter the predominantly hydrocarbon substituent (e.g., halo (especially chloro and fluoro), hydroxy, alkoxy, mercapto, alkylmercapto, nitro, nitroso, amino, alkylamino, and sulfoxy); and

(c) hetero substituents, that is, substituents which, while having a predominantly hydrocarbon character, in the context of this disclosure, contain other than carbon in a ring or chain otherwise composed of carbon atoms. Heteroatoms may include sulfur, oxygen, and nitrogen, and encompass substituents such as pyridyl, furyl, thienyl, and imidazolyl. In general, no more than two, for example, no more than one, non-hydrocarbon substituent will be present for every ten carbon atoms in the hydrocarbyl group; typically, there will be no non-hydrocarbon substituents in the hydrocarbyl group.

The term “alkyl” as employed herein refers to straight, branched, cyclic, and/or substituted saturated chain moieties of from about 1 to about 100 carbon atoms.

The term “alkenyl” as employed herein refers to straight, branched, cyclic, and/or substituted unsaturated chain moieties of from about 3 to about 100 carbon atoms.

The term “aryl” as employed herein refers to single and multi-ring aromatic compounds that may include alkyl, alkenyl, alkylaryl, amino, hydroxyl, alkoxy, halo substituents, and/or heteroatoms including, but not limited to, nitrogen, oxygen, and sulfur.

The term “fuel soluble” as used herein and in the claims does not necessarily mean that all the compositions and/or components in question are miscible or soluble in all proportions in all fuels. Rather, it is intended to mean that the composition is soluble in a fuel (hydrocarbon, non-hydrocarbon, mixtures, etc.) in which it is intended to function to an extent which permits the solution to exhibit one or more of the desired properties. Similarly, it is not necessary that such “solutions” be true solutions in the strict physical or chemical sense. They may instead be micro-emulsions or colloidal dispersions which, for the purpose of this invention, exhibit properties sufficiently close to those of true solutions to be, for practical purposes, interchangeable with them within the context of this invention.

The fuel additive component of the present application may be used in a fuel composition containing greater than 50 wt. % of fuel and may be added to the fuel directly or added as a component of an additive concentrate to the fuel.

Suitable fuel additive components for use in the present invention include a fuel soluble detergent selected from compounds of the Formulae (I), (IIa), (IIIa) and (IIIb):

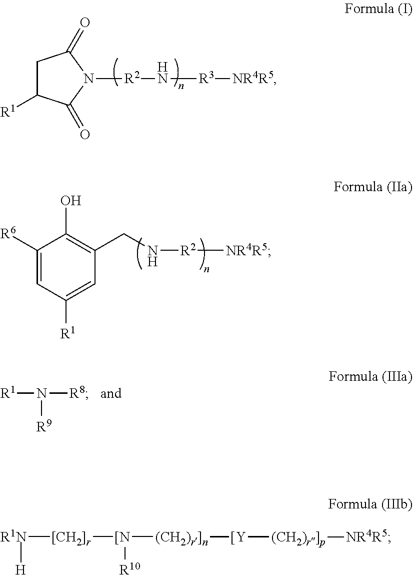

wherein n and p can be the same or different and each of n and p independently is 0, 1, 2, 3, 4, 5, 6, 7, or 8; r, r′, and r″ can be the same or different and each of r, r′, and r″ independently is an integer of from 2 to 6; Y is O or NR¹⁰; R¹ is an hydrocarbyl radical derived from a copolymer of ethylene and one or more C₃₋₁₀ alpha-olefins; the copolymer has a number average molecular weight of less than 5,000 g/mol as measured by GPC using polystyrene as a calibration reference. The ethylene unit content of the copolymer measured by ¹H-NMR spectroscopy is greater than 40 mol % and less than 90 mol %; a terminal unsaturation of 70 mol % or greater as measured by ¹³C NMR spectroscopy; and at least 70 mol % of the unsaturation is terminal vinylidene, one or more tri-substituted isomers of the terminal vinylidene and any combination thereof, as measured by ¹H-NMR spectroscopy. The copolymer has an actual average ethylene run length n_{C2,Actual}, as measured by ¹³C NMR spectroscopy, of less than 2.6. The copolymer also satisfies the relationship:

n_{C2,Actual}>n_{C2,Statistical}

R² and R³ are each independently selected from a divalent C₁-C₆ alkylene; each of R⁴ and R⁵, independently, is H, C₁-C₆ alkyl,

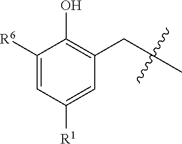

or, together with the N to which they are attached to, form a 5 or 6-membered ring optionally fused with a non-aromatic or an aromatic ring having the following formula

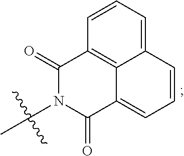 [SMILES: *N1C(=O)c2cccc3cccc(c23)C1=O]

R⁶ is H or C₁-C₆ alkyl, or —CH₂—(NH—R²)ₙ—NR⁴R⁵, or R⁶ may be the same as R¹ or if R¹ and R⁶ are not the same, the positions of R¹ and R⁶ may be switched; R⁷, R⁸, R⁹ and R¹⁰ are independently selected from the group consisting of hydrogen, C₁ to C₂₅ straight or branched chain alkyl groups; C₂ to C₁₂ alkoxy C₂ to C₆ alkylene groups; C₂ to C₁₂ hydroxy amino alkylene groups; and C₁ to C₁₂ alkylamino C₂ to C₆ alkylene groups; and wherein R¹⁰ can additionally comprise a group of the formula:

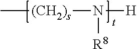

wherein R⁸ is as defined above and wherein s is an integer of from 2 to 6 and t is an integer from 0 to 10.

The fuel soluble detergent may be present in the fuel composition in an amount of from 10 to 500 ppmw, or from 20 to 300 ppmw, or from 40 to 200 ppmw. In certain embodiments, the detergent component is substantially free of ash forming components.

### The Ethylene-Alpha-Olefin Copolymers

Detergents derived from ethylene-C₃-C₁₀ alpha olefin copolymers, fuel compositions incorporating these detergents, and related methods are generally described herein. The copolymer may comprise ethylene-derived units and C₃-C₁₀ alpha-olefin-derived units. The C₃-C₁₀ alpha-olefin-derived units may have a carbon number of 3, 4, 5, 6, 7, 8, 9, or 10. For example, the C₃-C₁₀ alpha-olefin-derived units may be propylene-derived units.

An ethylene-derived unit generally refers to a —CH₂CH₂— unit within a copolymer chain, which is derived from an ethylene molecule during copolymerization, with a similar definition applying to C₃-C₁₀ alpha-olefin-derived unit or any other specified derived unit. The term “olefin” is given its ordinary meaning in the art, e.g., referring to a family of organic compounds which are alkenes with a chemical formula CₓH₂ₓ, where x is the carbon number, and having a double bond within its structure. The term “alpha-olefin” is given its ordinary meaning in the art and refers to olefins having a double bond within its structure at the primary or alpha position.

According to one or more embodiments, ethylene-C₃-C₁₀ alpha olefin copolymers are generally disclosed. The copolymer may comprise ethylene-derived units and C₃-C₁₀ alpha-olefin-derived units, wherein the C₃-C₁₀ alpha-olefin has a carbon number of three to ten. Thus, the carbon number of the C₃-C₁₀ alpha-olefin may be 3, 4, 5, 6, 7, 8, 9, or 10. For example, according to some embodiments, the C₃-C₁₀ alpha-olefin-derived units are propylene-derived units. In some embodiments, the C₃-C₁₀ alpha-olefin-derived units may be 1-butylene-, 1-pentene-, 1-hexene-, 1-heptene-, 1-octene-, 1-nonene-, or 1-decene-derived units.

### Crossover Temperature

One characteristic of the copolymer that helps to define its behavior in low temperatures is its crossover temperature, or onset temperature. A copolymer may generally be viscoelastic; in other words, its mechanical properties are between that of a purely elastic solid and that of a purely viscous liquid. The viscoelastic behavior of the copolymer may be characterized as the combination of an elastic portion (referred to, alternatively, as an elastic modulus or a storage modulus), and a viscous portion (referred to, alternatively, as a viscous modulus or a loss modulus). The values of these moduli are used to characterize the viscoelastic properties of the copolymer at a certain temperature. A copolymer that has a relatively higher elastic portion and a relatively lower viscous portion will behave more similarly to a purely elastic solid, while a copolymer that has a relatively lower elastic portion and a relatively higher viscous portion will behave more similarly to a purely viscous liquid. Both the storage modulus and the loss modulus are each functions of temperature, although they may change at different rates as a function of temperature. In other words, the copolymer may exhibit more elasticity or more viscosity, depending on the temperature. The highest temperature at which a value of a storage modulus of the copolymer equals a value of a loss modulus being measured by oscillatory rheometry is referred to as the crossover temperature or the onset temperature.

Oscillatory rheology is one technique that may be used to measure values (generally expressed in units of pressure) for the loss and storage moduli. The basic principle of an oscillatory rheometer is to induce a sinusoidal shear deformation in the sample (e.g., a sample of copolymer) and measure the resultant stress response. In a typical experiment, the sample is placed between two plates. While the top plate remains stationary, a motor rotates or oscillates the bottom plate, thereby imposing a time dependent strain on the sample. Simultaneously, the time dependent stress is quantified by measuring the torque that the sample imposes on the top plate.

Measuring this time dependent stress response reveals characteristics about the behavior of the material. If the material is an ideal elastic solid, then the sample stress is proportional to the strain deformation, and the proportionality constant is the shear modulus of the material. The stress is always exactly in phase with the applied sinusoidal strain deformation. In contrast, if the material is a purely viscous fluid, the stress in the sample is proportional to the rate of strain deformation, where the proportionality constant is the viscosity of the fluid. The applied strain and the measured stress are out of phase.

Viscoelastic materials show a response that contains both in-phase and out-of-phase contributions. These contributions reveal the extents of solid-like and liquid-like behavior. A viscoelastic material will show a phase shift with respect to the applied strain deformation that lies between that of solids and liquids. These can be decoupled into an elastic component (the storage modulus) and a viscosity component (the loss modulus). The viscoelastic behavior of the system thus can be characterized by the storage modulus and the loss modulus, which respectively characterize the solid-like and fluid-like contributions to the measured stress response.

As mentioned, the values of the moduli are temperature dependent. At warmer temperatures, the value of the loss modulus for the copolymer is greater than the value of the storage modulus. However, as the temperature decreases, the copolymer may behave more like an elastic solid, and the degree of contribution from the storage modulus approaches that from the loss modulus. As the temperature lowers, eventually, at a certain temperature the storage modulus crosses the loss modulus of the pure copolymer, and becomes the predominant contributor to the viscoelastic behavior of the pure copolymer. As stated above, the temperature at which the storage modulus equals the loss modulus of the pure copolymer is referred to as the crossover temperature or the onset temperature. According to one or more embodiments, a lower crossover temperature of the copolymer correlates to better low temperature performance of oils into which the copolymer is incorporated.

Thus, according to one or more embodiments, the copolymer may have a crossover temperature, that is to say, a temperature at which the storage modulus of the copolymer is equal to the loss modulus of the copolymer, of −20° C. or lower, −25° C. or lower, −30° C. or lower, −35° C. or lower, or −40° C. or lower, or −50° C. or lower, −60° C. or lower, −70° C. or lower; e.g., as measured by oscillatory rheometry. Other values are also possible. An advantageous crossover temperature for the copolymer may be achieved through controlling characteristics of the copolymer during its manufacture, as discussed herein. One such characteristic is an average ethylene run length.

### Average Ethylene Run Length and Triad Distribution

According to one or more embodiments, the sequence of the ethylene-derived units and C₃-C₁₀ alpha-olefin-derived units within the copolymer may be arranged in such a way as to provide good low temperature performance. The sequential arrangement of the different units may be characterized by an average ethylene run length.

As used herein, “average ethylene run length” refers to the average ethylene monomer unit run length incorporated into the copolymer. The average ethylene-derived unit run length is defined as the total number of ethylene-derived units in the copolymer divided by a number of runs of one or more sequential ethylene-derived triad units in the copolymer, and the average ethylene-derived unit run length n_{c2}.

In a copolymer comprising ethylene and alpha-olefin monomer units (e.g., ethylene and propylene monomer moieties), neither of the monomer units will be distributed uniformly along the chain of the copolymer. Instead, the monomer units will be randomly distributed. For example, in a representative copolymer comprising four monomer units of A, and four monomer moieties of B, the monomer units may be distributed as follows: A-A-B-A-B-B-B-A, or in any other manner. The average run length of a monomer unit within the copolymer is measured by dividing the total number of that monomer unit within the copolymer by the number of separate runs of that monomer unit. In the above example, there are a total of four monomer units of A and three separate runs of A. Therefore, the average A run length is 1.33. There are a total of four monomer units of B and two separate runs of B. Therefore, the average B run length is 2.0.

The theoretical average ethylene run length (n_{C2,Statistical}) for the copolymers herein can be calculated from Bernoullian statistics, shown in Equation 1 below. Equation 1 uses the measured mole fraction of ethylene incorporated in the copolymer, x_{C2}, to calculate the theoretical mole fraction of particular triads, which is used to calculate n_{C2,Statistical}. Triads are the possible combinations of three sequential monomer moieties in a copolymer. For example, in an ethylene-propylene copolymer, where “E” represents an ethylene monomer unit and “P” represents a propylene monomer unit, potential combinations for triads include: E-E-E, E-E-P, P-E-P, E-P-E, P-P-E, and P-P-P.

To calculate the theoretical average ethylene run length (n_{C2,Statistical}), the mole fraction of ethylene incorporated in the copolymer, x_{C2}, is measured by ¹H-NMR spectroscopy. x_{C2} is then inserted into Equations 2-4 to calculate the mole fractions of the triads, EEE, EEA, AEE, and AEA to determine n_{C2,Statistical} for a purely theoretical copolymer based on the statistical distributions of the triads.

$$\begin{matrix}{n}_{C 2 , Statistical} = \frac{( EEE ) + ( AEE + EEA ) + ( AEA )}{( AEA ) + 0.5 ( AEE + EEA )} & ( Equation 1 ) \\ ( EEE ) = {( {x}_{C 2} )}^{3} & ( Equation 2 ) \\ ( AEE + EEA ) = 2 {( {x}_{C 2} )}^{2} ( 1 - {x}_{C 2} ) & ( Equation 3 ) \\ ( AEA ) = {{x}_{C 2} ( 1 - {x}_{C 2} )}^{2} & ( Equation 4 )\end{matrix}$$

The copolymers used to make the detergents have an actual average ethylene run length (n_{C2, Actual}) that is less than the statistical average ethylene run length (n_{C2,Statistical}). the actual average ethylene run length (n_{C2,Actual}) may be calculated by measuring the triad distribution in the copolymer. The “triad distribution” is the sequential arrangement of monomer units in the copolymer. It refers to the statistical distribution of the possible combinations of three subunits in a row in a copolymer chain. Taking as an example an ethylene-propylene copolymer, where “E” represents an ethylene-derived unit and “P” represents a propylene-derived unit, potential combinations for monomer unit triads include: E-E-E, E-E-P, P-E-E, P-E-P, E-P-E, P-P-E, E-P-P and P-P-P. According to one or more embodiments, the amount of E-E-E is less than 20%, less than 10%, or less than 5%, an indication of a relatively short n_{C2,Actual}.

The method used for calculating the triad distribution of ethylene-propylene copolymers is described in J. C. Randall JMS-Review Macromolecules Chem Physics C29, 201 (1989) and E. W. Hansen, K. Redford Polymer Vol. 37, No. 1, 19-24 (1996). After collecting ¹³C NMR data under quantitative conditions, eight regions (A-H), shown in Table 2 are integrated. The equations of Table 3 are applied and the values normalized. For the examples described herein, the D, E, and F regions were combined due to peak overlap, k is a normalization constant and T=total intensity. The factor k is the NMR proportionality constant relating the observed resonance intensities to the number of contributing molecular species. It can later be removed through normalization once a complete set of triads is obtained, as explained in J. C. Randall JMS-Review Macromolecules Chem Physics C29, 201 (1989). Tables 2 and 3 are specifically intended to calculate the mole fraction of triads found within an ethylene-proplylene copolymer. It is within one of skill in the art to modify the C¹³ NMR data collection to calculate the triad mole fractions of copolymers comprising ethylene derived units and other C₄-C₁₀ alpha olefin derived units.

TABLE 1
Integral Regions

| | Chemical |
|---|---|
| | Shift |
| Region | (ppm) |
| A | 43.5-48.0 |
| B | 36.5-39.5 |
| C | 32.5-33.5 |
| D | 29.2-31.2 |
| E | 28.5-29.3 |
| F | 26.5-27.8 |
| G | 23.5-25.5 |
| H | 19.5-22.5 |

TABLE 2
Equations

k(EEE) = 0.5(T_{DEF} + T_{A} + T_{C} + 3T_{G} − T_{B} − 2T_{H})
K(PEE + EEP) = 0.5(T_{H} + 0.5T_{B} − T_{A} − 2T_{G})
k(PEP) = T_{G}
k(EPE) = T_{C}
k(EPP + PPE) = 0.5(2T_{H} + T_{B} − 2T_{A} − 4T_{C})
k(PPP) = 0.5(3T_{A} + 2T_{C} − 0.5T_{B} − T_{H})

The calculated mole fraction of the EEE, EEA, AEE and AEA triads are entered into Equation 5 in order to obtain n_{C2,Actual}. When measurements and calculations from an ethylene-propylene copolymer are used in Equation 5, AEE is PEE, EEA is EEP, and AEA is PEP.

$${n}_{C 2 , Actual} = \frac{( EEE ) + ( AEE + EEA ) + ( AEA )}{( AEA ) + 0.5 ( AEE + EEA )} . \qquad ( Equation 5 )$$

The copolymers used to make the detergents have an actual average ethylene run length (n_{C2,Actual}) less than the theoretical average ethylene run length (n_{C2,Statistical}) and thus satisfy the relationship below:

n_{C2,Actual}>n_{C2,Statistical} (Equation 6).

Not only do the copolymers used to make the detergents herein have an n_{C2,Actual} less than n_{C2,Statistical}, but the copolymers must also have a n_{C2,Actual} less than 2.6. The detergents comprising olefin copolymers herein having an n_{C2,Actual} less than 2.6 exhibit improved performance. Accordingly, the copolymers of the detergents herein may have n_{C2,Actual} less than 2.5, less than 2.4, less than 2.3, less than 2.1, less than 2.0, or less than 1.9.

For the copolymers herein, the amount of E-E-E may be less than about 20%, less than about 10%, or less than about 5%, which is an indication of a relatively short average ethylene run length.

Copolymers having the properties described above, i.e., a measured average ethylene run length of less than 2.6 and satisfying Equation (6) have improved properties. Detergents comprising these copolymers when used in lubricants have improved low temperature properties.

According to one or more embodiments, the copolymer may be synthesized by a process through which the

n_{C2,Actual}>n_{C2,Statistical} (Equation 6).

Where the average run length is less than what would be expected from random distribution, the copolymer is between statistical and alternating. Alternatively, where the average run length is greater than would be expected from random distribution, the copolymer is between statistical and blocky.

According to one or more embodiments, the average ethylene run length in the copolymer is, at least in part, a function of the percentage of ethylene units in the copolymer, and the chosen catalysts. For example, a higher percentage of ethylene units will naturally result in a higher average run length. The choice of catalyst affects the average run length, because the catalyst affects the relative rate of insertion of the different units.

Thus, using an ethylene-propylene copolymer as an illustrative example, during copolymer chain formation, the reaction rate at which an ethylene molecule bonds to a preceding ethylene unit at the end of the growing polymer chain is referred to as the ethylene-ethylene propagation reaction rate constant (“k_{pEE}”). The reaction rate at which a propylene (or other C₃-C₁₀ alpha-olefin co-monomer) bonds to an ethylene unit at the end of the growing polymer chain is referred to as the ethylene-propylene propagation reaction rate constant (“k_{pEP}”). The reactivity ratio of ethylene (“r_{E}”) refers to the ratio of the ethylene-ethylene reaction rate constant to the ethylene-propylene propagation reaction rate constant, k_{pEE}/k_{pEP}.

Likewise, the reaction rate at which a propylene (or other C₃-C₁₀ alpha-olefin) molecule bonds to a propylene-derived unit at the end of the growing polymer chain is referred to as the propylene-propylene reaction rate constant (“k_{pPP}”). The reaction rate at which a ethylene molecule bonds to a propylene unit at the end of the growing polymer chain is referred to as the ethylene-propylene reaction rate constant (“k_{pPE}”). The reactivity ratio of propylene (“r_{P}”) refers to the ratio of the propylene-propylene reaction rate constant to the propylene-ethylene reaction rate constant, k_{pPP}/k_{pPE}.

The lower each of the reactivity ratios (r_{E} or r_{P}) are, the more likely it is that a different unit will follow the one preceding (e.g., ethylene follow propylene or vice versa) and the resulting polymer chain will have an alternating character, with a lower average ethylene run length than would otherwise be expected from a purely random distribution of units. According to one or more embodiments, selection of an appropriate catalyst as discussed herein, as well as control of other process parameters, may reduce the reactivity ratios and therefore the average ethylene run length, e.g., when copolymerized with propylene or other C₃-C₀₀ alpha olefins as discussed herein.

A lower average ethylene run length may provide certain advantages. For example, it may result in a lower crossover temperature for the copolymer. In general, without wishing to be bound by any theory, it is believed that the shorter the average ethylene run length for a given ethylene unit content, the lower the crossover temperature of the copolymer.

According to one or more embodiments, a copolymer comprising ethylene-derived units and C₃-C₁₀ alpha-olefin-derived units has:

n_{C2,Actual}>n_{C2,Statistical} (Equation 6).

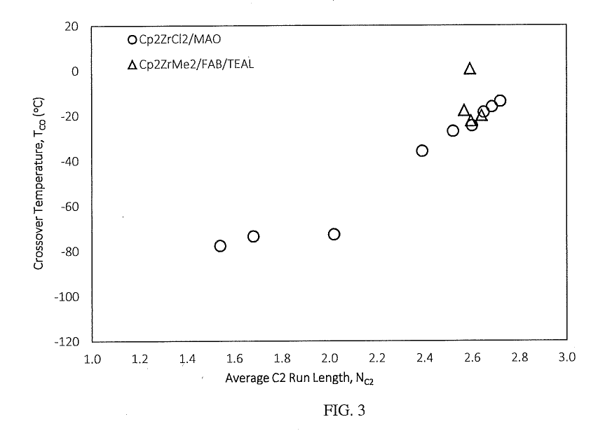

For example, as shown in FIG. 2, use of a coordination polymerization catalyst comprising the coordinated metallocene, Cp₂ZrCl₂, and methylaluminoxane as a co-catalyst under certain reaction conditions, results in the production of a copolymer having an average ethylene run length that is less than the statistically expected run length for a random distribution at a given percentage of ethylene units.

According to one or more embodiments, the copolymer may have an average ethylene run length that is less than 3.0, less than 2.9, less than 2.8ethylene, less than 2.7, less than 2.6, less than 2.5, less than 2.4, less than 2.3, less than 2.1, or less than 2.0.

### Statistical and Alternating Microstructures

Copolymers of ethylene (C₂) and propylene (C₃) produced with perfectly alternating microstructures would not have a distribution of C₂ run lengths, as every ethylene sequence is exactly the same. The ethylene run length for a perfectly alternating microstructure is calculated from Equation (7).

$${n}_{C 2 , Alternating} = \frac{{x}_{{C}_{2}}}{( 1 - {x}_{{C}_{2}} )} . \qquad Equation ( 7 )$$

However, copolymers that do not have a perfectly alternating microstructure would have a distribution of C₂ run lengths, and the prediction of a purely statistical microstructure represents the average C₂ run length (also referred to as, the “average ethylene run length”) for the distribution of C₂ run lengths. The average C₂ run length for copolymers produced with a purely statistical microstructure can be calculated from Bernoullian statistics, shown in Equation (2). The mole fraction of ethylene incorporated in an ethylene-propylene copolymer, x_{C2}, is used to calculate the fraction of EEE, EEP, PEE and PEP (there are also EPE, PPE, EPP and PPP triads) triads in a purely statistical copolymer through Equations (1)-(4).

$$\begin{matrix}{n}_{C 2 , Statistical} = \frac{( EEE ) + ( AEE + EEA ) + ( AEA )}{( AEA ) + 0.5 ( AEE + EEA )} & ( Equation 1 ) \\ ( EEE ) = {( {x}_{C 2} )}^{3} & ( Equation 2 ) \\ ( AEE + EEA ) = 2 {( {x}_{C 2} )}^{2} ( 1 - {x}_{C 2} ) & ( Equation 3 ) \\ ( AEA ) = {{x}_{C 2} ( 1 - {x}_{C 2} )}^{2} & ( Equation 4 )\end{matrix}$$

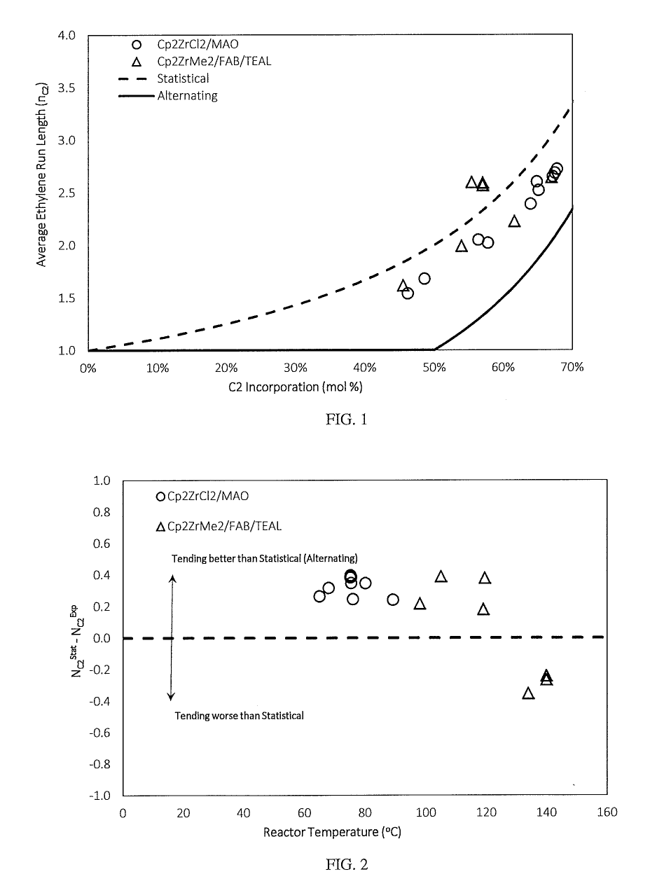

The actual C₂ incorporation in mol % can be measured using ¹H-NMR or ¹³C NMR using standard techniques known to those of ordinary skill in the art. The actual average C₂ run length can be determined from 13C-NMR using standard techniques. The comparison between the actual average C₂ run length and the calculations for the alternating and statistical results are shown in FIG. 1 at different ethylene incorporations. A comparison of the actual average C₂ run length to the calculated statistical and alternating results yields an indication of whether the copolymers produced have microstructures worse or better than statistical. Without being bound by any theory, it is believed that microstructures that are worse than statistical have a broader distribution of C₂ run lengths about the average.

Increasing the ethylene unit content of the copolymer increases the plasticization efficiency, plasticization durability, and oxidative stability of the plasticizer but also decreases the amount of structure forming that may occur at lower temperatures. It is unexpected that the particular combination of properties and microstructure of the copolymer of the present invention provides adequate plasticization efficiency, plasticization durability, and oxidative stability while at the same time providing a good low temperature performance.

The results shown in FIG. 1 were produced with two different catalyst systems. The ethylene incorporation was controlled during the polymerization using standard techniques known in the art. The copolymerization using the Cp₂ZrCl₂/MAO catalyst system was carried out at a lower temperature and within a narrower temperature range than the copolymerization using the Cp₂ZrMe₂/FAB/TEAL catalyst system, shown in FIG. 2.

The copolymerization reaction can be controlled to provide the desired copolymers of the invention. Parameters such as the reaction temperature, pressure, mixing, reactor heat management, feed rates of one or more of the reactants, types, ratio, and concentration of catalyst and/or co-catalyst and/or scavenger as well as the phase of the feed components can be controlled to influence the structure of the copolymer obtained from the reaction. Thus, a combination of several different reaction conditions can be controlled to produce the desired copolymer.

For example, it is important to run the copolymerization reaction with appropriate heat management. Since the copolymerization reaction is exothermic, in order to maintain a desired set point temperature in the reactor heat must be removed. This can be accomplished by, for example, two different methods often practiced in combination. Heat can be removed by cooling the feed stream to the reactor to a temperature well below the reaction set point temperature (even sometimes cryogenically) and therefore allowing the feed stream to absorb some of the heat of reaction through a temperature rise. In addition, heat can be removed from the reactor by external cooling, such as a cooling coil and/or a cooling jacket. The lower the set point temperature in the reactor, the more demand there is for heat removal. The higher the reaction temperature, the less heat needs to be removed, or alternatively or in combination, the more concentrated the copolymer can be (higher productivity) and/or the shorter the residence time can be (smaller reactor). The results characterizing the deviation of the average ethylene run length from a purely statistical microstructure are shown in FIG. 2 for both catalyst systems plotted versus the temperature of the reactor during the copolymerization.

As the reaction temperature was increased beyond 135° C., it appears that control of the microstructure may be lost and the copolymer typically becomes worse than statistical. As a result, the low temperature properties of the copolymer may be compromised. Without being bound by theory, the reduced control of the microstructure of copolymers produced at higher temperatures is believed to be due to a drop in the reaction kinetics of comonomer incorporation relative to ethylene incorporation. The more difficult it is for the comonomer to incorporate in the copolymer, the less regularly the comonomer breaks up the runs of ethylene units in the chain during copolymerization. Some strategies for improving the incorporation of comonomer at higher reaction temperatures include increasing the ratio of monomers of C₃-C₁₀ alpha-olefin/ethylene in the reactor, increasing the Al/Zr ratio in the catalyst or by making changes in the catalyst architecture.

Thus, in some embodiments of the invention, reaction temperatures of 60-135° C. are employed for the copolymerization reaction, or, more preferably, reaction temperatures of 62-130° C., or 65-125° C., or preferably 68-120° C. or 70-90° C., are employed for the copolymerization reaction.

Preferred Al/Zr ratio in the catalyst system may be less than 10,000:1, less than 1,000:1, less than 100:1, less than 10:1, less than 5:1, or less than 1:1. For boron containing technology, preferred Al/Zr ratio in the catalyst is less than 100:1, less than 50:1, less than 10:1, less than 5:1, less than 1:1, less than 0.1:1 and preferred B/Zr ratio is less than 10:1, less than 5:1, less than 2:1, less than 1.5:1, less than 1.2:1, or less than 1:1.

Low temperature properties of the copolymer can be correlated to the microstructure of the copolymer. Low temperature performance of the pure copolymer is measured by Oscillatory Rheometry. The point at which storage modulus is equal to the loss modulus, namely, the crossover or onset temperature, is an indication of the temperature at which the copolymer will begin to exhibit unfavorable structure forming. The crossover temperature is the point at which the structure formed in the copolymer exceeds the liquid-like character of the copolymer. This temperature has been shown to be predictive for determining the impact of the copolymer structure on low temperature performance as a polyolefin plasticizer.

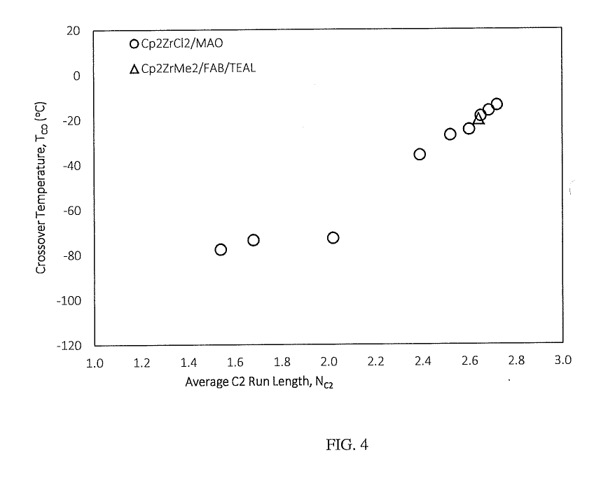

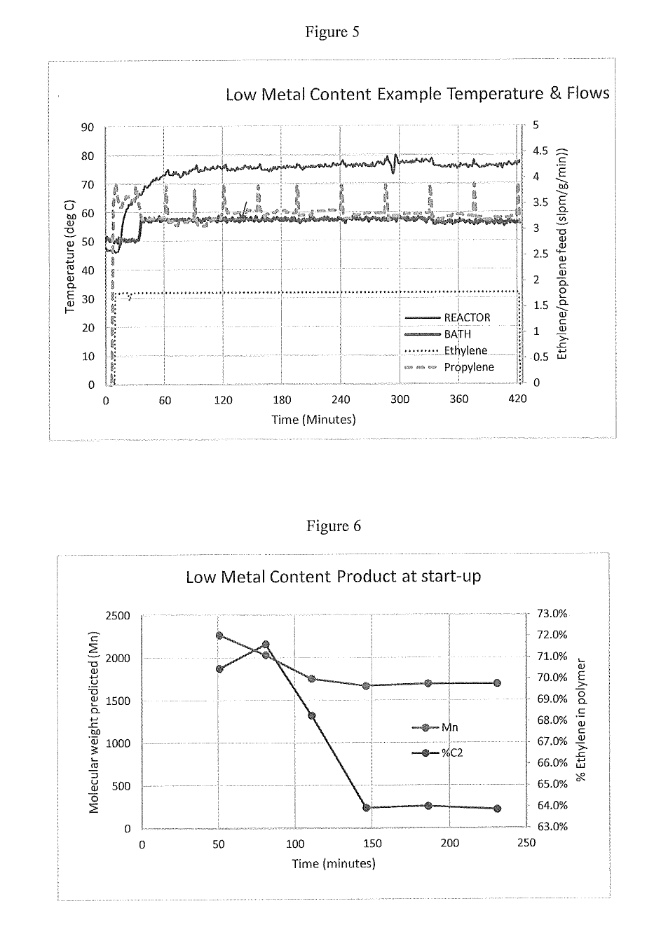

The impact of average ethylene run length on crossover temperature is shown in FIG. 3. The copolymers produced with the Cp₂ZrCl₂/MAO catalyst system are well-behaved and there is a strong correlation between crossover temperature and average ethylene run length. The copolymers produced with the Cp₂ZrMe₂/FAB/TEAL catalyst system can be controlled to provide the desired combination crossover temperature and average ethylene run length. A particularly wide range of crossover temperatures is observed for the copolymers produced using the Cp₂ZrMe₂/FAB/TEAL catalyst system is shown in FIG. 3. Specifically, at an approximate average C₂ unit run length of 2.6, the crossover temperature of these copolymers varies from almost −40° C. to about 5° C. This wide range in crossover temperature correlates with the wide variety of different microstructures that was also observed for these copolymers at the same average ethylene run length. In FIG. 4 only the data exhibiting better than statistical microstructures are included.

### The Number Average Molecular Weight

The number average molecular weight Mn) of the copolymer is determined by gel permeation chromatography (GPC) using polystyrene (with a Mn of 180 to about 18,000) as the calibration reference, as described in U.S. Pat. No. 5,266,223. The GPC method additionally provides molecular weight distribution information; see W. W. Yau, J. J. Kirkland and D. D. Bly, “Modern Size Exclusion Liquid Chromatography,” John Wiley and Sons, New York, 1979. According to some embodiments, the copolymer may have a number average molecular weight (Mn) of less than 5,000 g/mol, of less than 4,500 g/mol, of less than 4,000 g/mol, of less than 3,500 g/mol, of less than 3,000 g/mol, of less than 2,800 g/mol, of less than 2,500 g/mol, of less than 2,000 g/mol, of less than 1,500 g/mol, or of less than 1,000 g/mol as determined by GPC utilizing the polystyrene standard. According to some embodiments, the copolymer may have a number average molecular weight of greater than 200 g/mol, of greater than 500 g/mol, of greater than 800 g/mol, or of greater than 1,000 g/mol, as determined by GPC. Combinations of any of the above-referenced ranges are also possible (for example, about 200 g/mol to about 1,500 g/mol, at least about 700 g/mol and less than about 1,500 g/mol, at least about 800 g/mol and less than about 1,500 g/mol, or at least about 500 g/mol and less than about 1,500 g/mol and so forth, with all the above noted endpoints). In some embodiments, the Mn of the copolymer is at least about 700 g/mol to about 1400 g/mol.

The polydispersity index (PDI) of the copolymer is a measure of the variation in size of the individual chains of the copolymer. The polydispersity index is determined by dividing the weight average molecular weight (Mw) of the copolymer by the number average molecular weight (Mn) of the copolymer. The term number average molecular weight (Mn) is given its ordinary meaning in the art, and is defined as the sum of the products of the weight of each polymer chain and the number of polymer chains having that weight, divided by the total number of polymer chains. The weight average molecular weight of the copolymer is given its ordinary meaning in the art and is defined as the sum of the products of the weight squared of each polymer chain and the total number of polymer chains having that weight, divided by the sum of the products of the weight of each polymer chain and the number of polymer chains having that weight. According to one or more embodiments, the PDI of the copolymer may be less than or equal to 4, less than or equal to 3, less than or equal to 2, or less than or equal to 1.

### Ethylene Unit Content

The copolymer may comprise a certain mole percentage (mol %) of ethylene-derived units in some embodiments. According to some embodiments, the ethylene unit content of the copolymer, relative to the total amount of the units within the copolymer, is at least 10 mol %, at least 20 mol %, at least 30 mol %, at least 40 mol %, at least 45 mol %, at least 50 mol %, at least 55 mol %, at least 60 mol %, at least 65 mol %, at least 70 mol %, or at least 75 mol %. According to some embodiments, the ethylene unit content of the copolymer is less than 90 mol %, less than 87 mol %, less than 85 mol %, less than 80 mol %, less than 75 mol %, less than 70 mol %, less than 65 mol %, less than 60 mol %, less than 55 mol %, less than 50 mol %, less than 45 mol %, less than 40 mol %, less than 30 mol %, or less than 20 mol %, Combinations of the above-referenced ranges are also possible (e.g., at least 10 mol % and less than 90 mol %, at least 20 mol % and less than 87 mol %, at least 30 mol % and less than 85 mol %, at least 40 mol % and less than 80 mol %).

### Comonomer Unit Content

The copolymer may comprise a certain mole percentage of comonomer units, where the comonomer is selected from a group consisting of C₃-C₁₀ alpha-olefins having a carbon number at or between 3 and 10, e.g., propylene. According to some embodiments, the comonomer unit content of the copolymer, relative to the total amount of the monomers within the copolymer, is at least 10 mol %, at least 13 mol %, at least 15 mol %, at least 20 mol %, at least 25 mol %, at least 30 mol %, at least 35 mol %, at least 40 mol %, at least 45 mol %, at least 50 mol %, at least 55 mol %, at least 60 mol %, at least 65 mol %, at least 70 mol %, or at least 80 mol %. According to some embodiments, the comonomer unit content of the copolymer is less than 90 mol %, less than 80 mol %, less than 70 mol %, less than 65 mol %, less than 60 mol %, less than 55 mol %, less than 50 mol %, less than 45 mol %, less than 40 mol %, less than 35 mol %, less than 30 mol %, less than 25 mol %, less than 20 mol %, less than 90 mol %, as measured by ¹H NMR spectroscopy. Combinations of the above reference ranges are possible (e.g., at least 40 mol %, and less than 60 mol %). Other ranges are also possible.

The term “olefin” is given its ordinary meaning in the art, and generally refers to a family of organic compounds which are alkenes with a chemical formula CₓH₂ₓ, where x is the carbon number and having a double bond within its structure. The term “alpha-olefin” is also given its ordinary meaning in the art and refers to olefins having a double bond within its structure at the primary or alpha position.

### Terminal Unsaturation

The copolymers herein may terminate with either an ethylene monomer unit or a C₃-C₁₀ alpha olefin monomer unit and include at least about 70 mol % terminal unsaturation. “Terminal unsaturation” refers to a carbon-carbon double bond wherein at least one of the carbons is derived from the terminal monomer unit, either the ethylene monomer unit or the C₃-C₁₀ alpha olefin monomer unit of the copolymer. The copolymer may have greater than 75 mol % terminal unsaturation, greater than 80 mol % terminal unsaturation, greater than 85 mol % terminal unsaturation, greater than 90 mol % terminal unsaturation, greater than 95 mol % terminal unsaturation, greater than 97 mol % terminal unsaturation. The mol % of terminal unsaturation is measured by ¹³C NMR. See, e.g., U.S. Pat. No. 5,128,056, which is incorporated herein by reference.

### Terminal Group

If the copolymer terminates in an ethylene monomer unit, the terminal group on the copolymer is vinyl or di-substituted isomer of vinyl. If the copolymer terminates in C₃-C₁₀ alpha-olefin monomer unit, the terminal group on the copolymer is a terminal vinylidene or a tri-substituted isomer of the terminal vinylidene. In the copolymer used to make the detergents described herein, at least 70 mol % of the terminal unsaturation is derived from a C₃-C₁₀ alpha olefin. That is, at least 70 mol % of the terminal unsaturation is a terminal vinylidene, one or more tri-substituted isomers of the terminal vinylidene or any combination thereof having one or more of the following structural Formulas IV-VI:

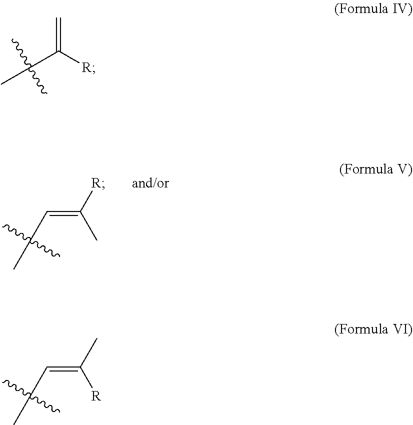

For Formulas IV-VI, R represents an alkyl (e.g., methyl if the terminal group is derived from propylene, ethyl if the terminal group is derived from 1-butene, etc.) and “ [symbol] ” indicates the bond is attached to the remaining portion of the copolymer. For the avoidance of doubt, one of skill in the art will understand that the first carbon atom to the right of “ [symbol] ” in Formulas (V) and (VI) is from the penultimate monomer unit.

The copolymer used to make the detergents herein may have greater than about 75 mol %, greater than about 80 mol %, greater than about 85 mol %, greater than about 90 mol %, or greater than about 95 mol %, terminal vinylidene, one or more tri-substituted isomers of the terminal vinylidene or any combination thereof, derived from a C₃-C₀₀ alpha olefin monomer.

As used herein, the term “terminal vinylidene” refers to the structure represented by Formula IV. As used herein, the term “tri-substituted isomer of terminal vinylidene” refers to the structures represented by Formulas V and/or VI. Terminal vinylidene, tri-substituted isomers of terminal vinylidene, and other types of terminal unsaturated bonds can be detected by ¹H-NMR. From the integrated intensity of each signal, the amount of each unsaturated bond can be determined, as discussed in U.S. Patent Publication No. 2016/0257862, which is incorporated herein by reference.

Low Metal and/or Fluorine Content

Low metal content copolymers are desirable for many uses due to the harmful effects of metals in various environments. For example, metals or ash can have an adverse impact on after-treatment devices employed in various types of engines. It is also desirable to ensure that the copolymers have a low fluorine content since fluorine is ecologically undesirable in many environments.

There are several methods to achieve a low metal content in the copolymer as described herein. The present invention incorporates methods known by those skilled in the art to purify and remove impurities. For example, in Giuseppe Forte and Sara Ronca, “Synthesis of Disentangled Ultra-High Molecular Weight Polyethylene: Influence of Reaction Medium on Material Properties,” International Journal of Polymer Science, vol. 2017, Article ID 7431419, 8 pages, 2017. doi:10.1155/2017/7431419, methods for purifying a polyethylene compound are disclosed. The method of purifying the copolymer comprises dissolving the copolymer in acidified methanol (CH₃OH/HCl) to a DCM (dichloromethane) solution of the polymer/catalyst mixture. This results in precipitation of the “purified” polymer, while the catalyst and other byproducts remain in solution. The copolymer may then be filtered and washed out with additional methanol, and oven dried under vacuum at 40° C.

According to one or more embodiments, the copolymer may be purified to achieve a low metal content by passing the polymer/catalyst mixture through an adsorption column. The adsorption column contains an adsorber, preferably, activated alumina.

In a more preferred embodiment, the copolymer may be purified to achieve a low metal content by stripping the polymer compositions using toluene and a rotavap with a temperature-controlled oil bath.

In an alternative embodiment, the copolymer does not require a purification step. In this embodiment, the copolymer of the present invention is preferably copolymerized using a catalyst having a catalyst productivity of from 200-1500 kg copolymer/gram of single-site catalyst, or from 350-1500 kg copolymer/gram of single-site catalyst, or from 500-1200 kg copolymer/gram of single-site catalyst, or from 500-800 kg copolymer/gram of single-site catalyst. Suitable single-site catalyst systems having these productivities may be selected from those known in the art. The catalysts may be selected for the production of copolymers having Mn's in the range of 700-1400 g/mol. or from 550-650 g/mol. Selection of a suitable single-site catalyst may eliminate the need for a wash step to achieve the low metal content of the copolymer.

Catalyst productivity, expressed as the kg polymer produced per gram of catalyst, may be improved by efficient catalyst systems. The present invention incorporates the use of catalyst systems known by those skilled in the art which are capable of achieving high catalyst productivities. For example, U.S. Pat. No. 9,441,063 relates to catalyst compositions containing activator-supports and half-metallocene titanium phosphinimide complexes or half-metallocene titanium iminoimidazolidides capable of producing polyolefins with high catalyst productivities of at least up to 202 kg polymer/g catalyst (551 kg polymer/g cat/hr with a 22 min residence time, See Example 5 and Table 1, Columns 47 and 48.) Also, U.S. Pat. No. 8,614,277 relates to methods for preparing isotactic polypropylene and ethylene-propylene copolymers. U.S. Pat. No. 8,614,277 provides catalyst systems suitable for preparing copolymers at catalyst productivity levels greater than 200 kg polymer/g catalyst. The catalysts provided therein are metallocenes comprising zirconium as their central atom. (See the examples in Tables 1a-1c).

The copolymer may comprise a metal or ash content of 25 ppmw or less, based on the total weight of the copolymer. Preferably, the metal or ash content of the copolymer is 10 ppmw or less, or more preferably 5 ppmw or less, or even more preferably 1 ppmw or less, based on the total weight of the copolymer. Typically, the metal or ash content of the copolymer is derived from the single-site catalyst and optional co-catalyst(s) employed in the copolymerization reactor.

These single-site catalysts may include metallocene catalysts. Zr and Ti metals are typically derived from such metallocene catalysts. Various co-catalysts may be employed in combination with the single-site catalyst. Such co-catalysts may include boron and aluminum metals, as well as ecologically undesirable fluorine atoms or compounds. Thus, the metal or ash content of the copolymers of the present invention is the total metal or ash including Zr. Ti, Al and/or B. Various suitable catalyst systems are described elsewhere herein.

The copolymers may have a fluorine content of less than 10 ppmw, or less than 8 ppmw, or less than 5 ppmw, based on the total weight of the copolymer. Typically, the fluorine will come from co-catalyst systems based on boron compounds such as perfluoroaryl boranes.

### Copolymerization

According to one or more embodiments, various methods are provided for synthesizing the copolymers described herein. One method is polymerizing ethylene and a C₃-C₁₀ alpha-olefin in the presence of a single-site coordination polymerization catalyst to produce a copolymer comprising ethylene-derived units and C₃-C₁₀ alpha-olefin-derived units.

According to one or more embodiments, the coordination polymerization catalyst may comprise a coordinated metallocene. A metallocene comprises cyclopentadienyl anions (“Cp”) bound to a metal center. The coordinated metallocene may comprise a zirconium. For example, the coordinated metallocene may comprise Cp₂ZrCl₂. The coordination polymerization catalyst may further comprises a co-catalyst. The co-catalyst may comprise, for example, methylaluminoxane.

The copolymer may be produced in a reactor. Parameters that may be controlled during the process include pressure and temperature. The reaction may be operated continuously, semi-continuously, or batchwise. The ethylene may be delivered to a reactor through a metered feed of ethylene gas. The additional C₃-C₁₀ alpha-olefin component (e.g., propylene) of the copolymer may be delivered through a separate metered feed. The catalyst and co-catalyst may be delivered to the reactor in solution. The weight percent of either the catalyst or co-catalyst in the solution may be less than 20 wt %, less than 15 wt %, less than 10 wt %, less than 8 wt %, less than 6 wt %, less than 5 wt %, less than 4 wt %, less than 3 wt %, less than 2 wt %, or less than 1 wt %, according to different embodiments. The components may then be mixed in the reactor. Examples of different processes for forming the copolymer are described in the examples below.

In some embodiments, the microstructures are obtained by uniformally spatially distributing the composition within a reactor. Methods of ensuring composition uniformity include, but are not limited to, agitation, feed locations of monomers, solvent and catalyst components, and methods for introducing. Additional factors that may impact compositional uniformity in some cases include ensuring operating at optimal temperature and pressure space that provides a single fluid phase with the reactor based on the reactor composition and quite possibly ensuring the reactor temperature and pressure conditions are above the entire vapor-liquid phase behavior envelope of the feed composition. It is also envisioned that premixing of two or more of the feed components may be important and the premixing time and mixing intensity of the feed components is important for control of uniformity within the reactor, at least in some cases. Another subtle but important feature of certain embodiments is to ensure no pockets of vapor exist within the reactor that would create a composition gradient either at a vapor-liquid interface or within the liquid. Lower temperatures are also believed to be important for controlling the reactivity ratios in a manner that leads to microstructures with better than statistical microstructures and tending toward alternating microstructures. Some or all of the above may be important for controlling the microstructure within a polymer chain and also the comonomer composition variation from chain to chain, in various embodiments.

### Copolymer Functionalization

According to one or more embodiments, the copolymer described herein may be functionalized through a variety of mechanisms to produce detergents useful in fuels. Detergents are typically polymeric materials with an oleophilic component providing fuel solubility and a polar component providing dispersancy. Detergents used in fuels typically are hydrocarbon polymers modified to contain nitrogen- and ester-based groups. In some cases, the detergents may include hydrocarbon polymers such as the copolymers described herein. Detergents may be used to maintain, in a suspension in fuel, any insolubles formed by oxidation, etc. during use, which may prevent sludge flocculation and precipitation. The amount of detergent employed may be dictated and controlled, for example, by the effectiveness of the particular material in achieving its detergent function The detergents can be formed by reaction of an ethylene-alpha olefin copolymer as discussed herein with a suitable functional moiety.

In some embodiments, the ethylene-C₃-C₁₀ alpha copolymer useful for making detergents has a number average molecular weight as measured by GPC less than 5000, less than 3500, or less than 2500; an ethylene unit content less than 90 mol %, less than 87 mol %, less than 85 mol %, less than 80 mol %, less than 75 mol %, less than 70 mol %, or 30-60 mol %; a terminal unsaturation of 70 mol % or greater, 85 mol % or greater, or 95 mol % or greater; at least 70 mol %, at least, %, or at least 90 mol % of the unsaturation is a terminal group having a terminal vinylidene, one or more tri-substituted isomers of the terminal vinylidene or any combination thereof; an average ethylene run length n_{c2}, as measured by ¹³C NMR spectroscopy, of less than 2.6, less than 2.5, or less than 2.4; and a cross over temperature less than −20° C., less than −30° C., or less than −40° C. Some copolymers may have, in various embodiments, one, two, three, four, or more of any of the above recitations. In some further embodiments, the above-described copolymer is used to prepare detergents through one of the following chemical mechanisms, e.g., a succinimide-succinimide approach, a Koch-approach, a Mannich-approach, a hydroformylation-reductive-amination approach, or a halogenation-amination approach.

As non-limiting examples, a detergent may be formed by reacting a copolymer as discussed herein with a suitable functional group, for example, via a terminal double bond, to produce a fuel soluble detergent selected from compounds of the Formulae (I), (IIa), (IIb), (IIIa) and (IIIb):

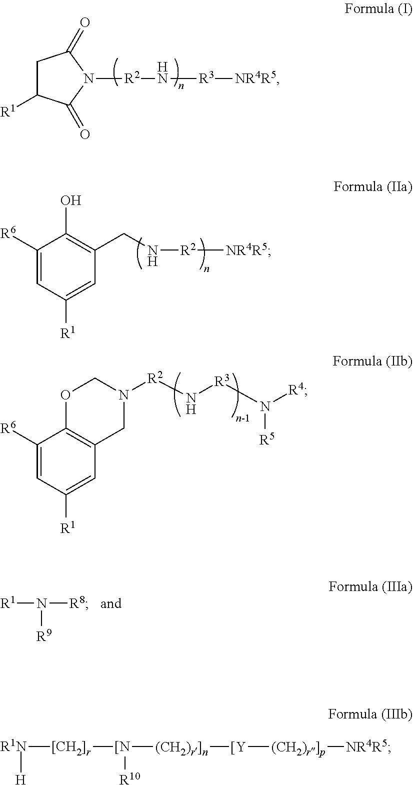

wherein n and p can be the same or different and each of n and p independently is 0, 1, 2, 3, 4, 5, 6, 7, or 8; r, r′, and r″ can be the same or different and each of r, r′, and r″ independently is an integer of from 2 to 6; Y is O or NR¹⁰; R¹ is an hydrocarbyl radical derived from a copolymer of ethylene and one or more C₃₋₁₀ alpha-olefins; the copolymer has a number average molecular weight of less than 5,000 g/mol as measured by GPC using polystyrene as a calibration reference. The ethylene unit content of the copolymer measured by ¹H-NMR spectroscopy is greater than 40 mol % and less than 90 mol %; a terminal unsaturation of 70 mol % or greater as measured by ¹³C NMR spectroscopy; and at least 70 mol % of the unsaturation is a terminal group having a terminal vinylidene, one or more tri-substituted isomers of the terminal vinylidene or any combination thereof, as measured by ¹H-NMR spectroscopy. The copolymer has an actual average ethylene run length n_{C2,Actual}, as measured by ¹³C NMR spectroscopy, of less than 2.6. The copolymer also satisfies the relationship:

n_{C2,Actual}>n_{C2,Statistical}

R² and R³ are each independently selected from a divalent C₁-C₆ alkylene; each of R⁴ and R⁵, independently, is H, C₁-C₆ alkyl,

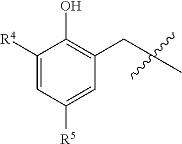

or, together with the N to which they are attached to, form a 5 or 6-membered ring optionally fused with a non-aromatic or an aromatic ring having the following formula

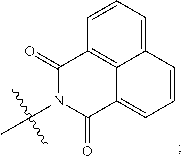 [SMILES: *N1C(=O)c2cccc3cccc(c23)C1=O]

R⁶ is H or C₁-C₆ alkyl, or —CH₂—(NH—R²)ₙ—NR⁴R⁵, or R⁶ may be the same as R¹ or if R¹ and R⁶ are not the same, the positions of R¹ and R⁶ may be switched; R⁷, R⁸, R⁹ and R¹⁰ are independently selected from the group consisting of hydrogen, C₁ to C₂₅ straight or branched chain alkyl groups; C₂ to C₁₂ alkoxy C₂ to C₆ alkylene groups; C₂ to C₁₂ hydroxy amino alkylene groups; and C₁ to C₁₂ alkylamino C₂ to C₆ alkylene groups; and wherein R¹⁰ can additionally comprise a group of the formula:

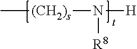

wherein R⁸ is as defined above and wherein s is an integer of from 2 to 6 and t is an integer from 0 to 10.

The detergents described herein, such as hydrocarbyl amines, succinimides, Mannich products, and quaternary ammonium salts, can be prepared, for example, by functionalizing the copolymer described above through a variety of well-known chemical mechanisms to incorporate a functional portion into the copolymer via the terminal double bond (see, e.g., the discussion of Formulas (IV)-(VI) above). Accordingly, the copolymers described herein can be used to produce suitable detergents by functionalizing the terminal double bond portions of the copolymers to form functionalized copolymer molecules, more than 70%, more than 75%, more than 80%, more than 85%, more than 90%, or more than 95% of which are derived from functionalizing the terminal double bond of Formulas (IV), (V), and/or (VI). For example, the functionalized portion may be produced by any chemical derivatization of atoms or chemical moiety of the copolymer discuss herein, for example, carbon-carbon bond groups (e.g., alkenyl, alkynyl), carbon-nitrogen bond groups, carbon-oxygen bond groups, carbon-sulfur bond groups, and the like. Examples of chemical derivatization include, for example, imidization, succinimide formation (succinimide approach), a Koch reaction (Koch-approach), a Mannich reaction (Mannich-approach), a hydroformylation-reductive-amination approach, or a halogenation-amination approach, e.g., as described below. Methods of functionalizing copolymers as taught, for example, in U.S. Pat. No. 5,936,041.

### Succinimide Detergents

The succinimide detergents may include compounds of the Formula (I):

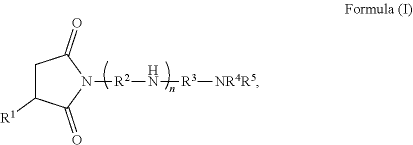

wherein n is 0, 1, 2, 3, 4, 5, 6, 7, or 8; R¹ is an hydrocarbyl radical derived from a copolymer of ethylene and one or more C₃₋₁₀ alpha-olefins; the copolymer has a number average molecular weight of less than 5,000 g/mol as measured by GPC using polystyrene as a calibration reference. The ethylene unit content of the copolymer measured by ¹H-NMR spectroscopy is greater than 40 mol % and less than 90 mol %; a terminal unsaturation of 70 mol % or greater as measured by ¹³C NMR spectroscopy; and at least 70 mol % of the unsaturation is a terminal group having a terminal vinylidene, one or more tri-substituted isomers of the terminal vinylidene or any combination thereof, as measured by ¹H-NMR spectroscopy. The copolymer has an actual average ethylene run length n_{C2,Actual}, as measured by ¹³C NMR spectroscopy, of less than 2.6. The copolymer also satisfies the relationship:

n_{C2,Actual}>n_{C2,Statistical}

R² and R³ are each independently selected from a divalent C₁-C₆ alkylene; and each of R⁴ and R⁵, independently, is H, C₁-C₆ alkyl,

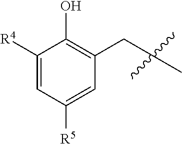

or, together with the N to which they are attached to, form a 5 or 6-membered ring optionally fused with a non-aromatic or an aromatic ring having the following formula

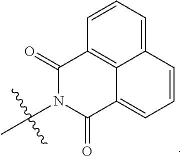 [SMILES: *N1C(=O)c2cccc3cccc(c23)C1=O]

Referring to Formula (I) above, the detergent can be mono-succinimide, i.e., NR⁴R⁵ together is NH₂, or bis-succinimide, i.e., NR⁴R⁵ together is:

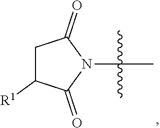

wherein R¹ is hydrocarbyl derived from the copolymer as described above.

Succinimide-functionalization refers to a process wherein the copolymer described herein is converted to a hydrocarbyl succinic acid or anhydride, i.e., the copolymer backbone substituted with one or more succinic acid or anhydride groups, which subsequently is reacted with a polyamine to form a hydrocarbyl succinimide. Hydrocarbyl succinic acid or anhydride can be made by derivatizing the terminal double bond with an unsaturated organic acid reagent via thermal ene reaction and/or halogenation-condensation. See, e.g., U.S. Pat. No. 7,897,696. In the hydrocarbyl succinic acid or anhydride, the ratio of succinic moiety:copolymer backbone is 1:1 to 2:1, preferably 1:1 to 1.6:1, more preferably 1.2:1-1.5:1.

The unsaturated organic acidic reagent of the disclosed process refers to an unsaturated substituted or un-substituted carboxylic acid reagent, for example maleic or fumaric reactants of the general formula:

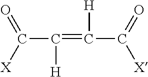

wherein X and X′ are the same or different, provided that at least one of X and X′ is a group that is capable of reacting to esterify alcohols, forming amides or amine salts with ammonia or amines, forming metal salts with reactive metals or basically reacting metal compounds, or otherwise functioning as an acylating agent. Typically, X and/or X′ is —OH, —O— hydrocarbyl, —NH₂, and taken together X and X′ can be —O— so as to form an anhydride. In some cases, X and X′ are such that both carboxylic functions can enter into acylation reactions.

Maleic anhydride is a suitable unsaturated acidic reactant. Other suitable unsaturated acidic reactants include electron-deficient olefins such as monophenyl maleic anhydride; monomethyl maleic anhydride, dimethyl maleic anhydride, N-phenyl maleimide and other substituted maleimides; isomaleimides; fumaric acid, maleic acid, alkyl hydrogen maleates and fumarates, dialkyl fumarates and maleates, fumaronilic acids and maleanic acids; and maleonitrile and fumaronitrile.

The percent actives of the hydrocarbyl succinic anhydride can be determined using a chromatographic technique. This method is described in column 5 and 6 in U.S. Pat. No. 5,334,321.

Conversion of hydrocarbyl succinic acid or anhydride to a succinimide is well known in the art and may be accomplished through the reaction of a polyamine with the hydrocarbyl succinic acid or anhydride, wherein the polyamine has at least one basic nitrogen in the compound, as described in U.S. Pat. Nos. 3,215,707 and 4,234,435. Suitable polyamines may have at least two nitrogen atoms and about 2 to 20 carbon atoms. One or more oxygen atoms may also be present in the polyamine. Suitable amines have at least one primary amino group.

A particularly suitable group of polyamines for use in the present disclosure are polyalkylene polyamines, including alkylene diamines. Such polyalkylene polyamines may contain from about 2 to about 12 nitrogen atoms and from about 2 to about 24 carbon atoms. Preferably, the alkylene groups of such polyalkylene polyamines may contain from about 2 to about 6 carbon atoms, more preferably from about 2 to about 4 carbon atoms.

Particularly suitable polyalkylene polyamines are those having the formula: H₂N—(R₁₅NH)ₐ—H, wherein R₁₅ is a straight- or branched-chain alkylene group having from about 2 to about 6 carbon atoms, preferably about 2 to about 4 carbon atoms, most preferably about 2 carbon atoms, i.e., ethylene (—CH₂CH₂—); and a is an integer from 1 to about 10, preferably 1 to about 4, and more preferably about 3.

Examples of suitable polyalkylene polyamines include, but are not limited to, ethylenediamine, propylenediamine, isopropylenediamine, butylenediamine, pentylenediamine, hexylenediamine, diethylenetriamine, dipropylenetriamine, dimethylaminopropylamine, diisopropylenetriamine, dibutylenetriamine, di-sec-butylenetriamine, triethyl enetetraamine, tripropylenetetraamine, triisobutylenetetraamine, tetraethylenepentamine, pentaethylenehexamine, dimethylaminopropylamine, and mixtures thereof.

Particularly suitable polyalkylene polyamines are ethylenediamine, diethylenetriamine, triethyl enetetraamine, tetraethylenepentamine, and pentaethylenehexamine.

Many of the polyamines suitable for use in the present disclosure are commercially available and others may be prepared by methods which are well known in the art. For example, methods for preparing amines and their reactions are detailed in Sidgewick's “The Organic Chemistry of Nitrogen,” Clarendon Press, Oxford, 1966; Noller's “Chemistry of Organic Compounds,” Saunders, Philadelphia, 2nd Ed., 1957; and Kirk-Othmer's “Encyclopedia of Chemical Technology,” 2nd Ed., especially Volume 2, pp. 99-116.

The reaction of polyamine and hydrocarbyl succinic acid or anhydride affords mono-succinimide, bis-succinimide, tris-succinimide, or other succinimides depending on the charge ratio of polyamine and succinic acid or anhydride. In some embodiments, the ratio between hydrocarbyl succinic acid/anhydride and polyamine is 1:1 to 3.2:1, or 2.5:1 to 3:1, or 2.9:1 to 3:1, or 1.6:1 to 2.5:1, or 1.6:1 to 2:1, or 1.6:1 to 1.8:1, 1.3:1 to 1.6:1, 1.4:1 to 1.6:1, or 1:1 to 1.5:1, or 1.2:1 to 1.3:1.

In embodiments where the fuel soluble detergent is a compound of the Formula (I), n is from 3-6. In the fuel soluble detergent of the Formula (I), a molar ratio of groups derived from succinic anhydride to groups derived from the polymer or copolymer may be from 1.0 to 2.0. The ratio of the equivalents of amino groups to carboxylic groups in the fuel soluble detergent of the Formula (I) may be from 0.6 to 1.6.

### Mannich Detergents

The Mannich detergents may include compounds of the Formulas (IIa) and (IIb):

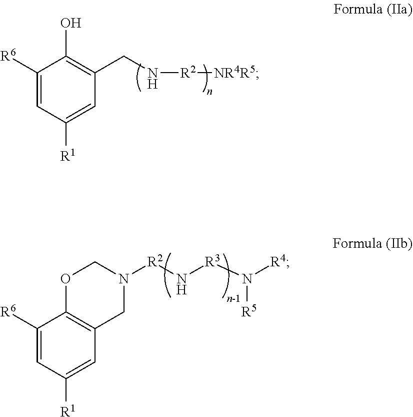

wherein n is 0, 1, 2, 3, 4, 5, 6, 7, or 8; r is an integer of from 2 to 6: s is an integer of from 2 to 10; t is an integer of from 1 to 3; R¹ is an hydrocarbyl radical derived from a copolymer of ethylene and one or more C₃₋₁₀ alpha-olefins; the copolymer has a number average molecular weight of less than 5,000 g/mol as measured by GPC using polystyrene as a calibration reference. The ethylene unit content of the copolymer measured by ¹H-NMR spectroscopy is greater than 40 mol % and less than 90 mol %; a terminal unsaturation of 70 mol % or greater as measured by 13C NMR spectroscopy; and at least 70 mol % of the unsaturation is a terminal group having a terminal vinylidene, one or more tri-substituted isomers of the terminal vinylidene or any combination thereof, as measured by ¹H-NMR spectroscopy. The copolymer has an actual average ethylene run length n_{C2,Actual}, as measured by ¹³C NMR spectroscopy, of less than 2.6. The copolymer also satisfies the relationship:

n_{C2,Actual}>n_{C2,Statistical}

R² and R³ are each independently selected from a divalent C₁-C₆ alkylene; each of R⁴ and R⁵, independently, is H, C₁-C₆ alkyl,

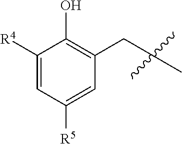

or, together with the N to which they are attached to, form a 5 or 6-membered ring optionally fused with a non-aromatic or an aromatic ring having the following formula

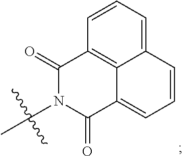 [SMILES: *N1C(=O)c2cccc3cccc(c23)C1=O]

and R⁶ is H or C₁-C₆ alkyl, or —CH₂—(NH—R²)ₙ—NR⁴R⁵, or R⁶ may be the same as R¹ or if R¹ and R⁶ are not the same, the positions of R¹ and R⁶ may be switched.

The Mannich detergents of the Formulas (IIa) and (IIb) can be made by the methods described in, for example, U.S. Pat. No. 5,285,851.

The Mannich reaction is an organic reaction involving amino alkylation of a carbon atom adjacent to a carbonyl functional group or a carbon atom that is part of an activated phenyl group (e.g., a hydroxyl aromatic compound) in a molecule. It is commonly used to make alkylphenol-derived detergent (also called Mannich detergents). In some embodiments of this invention, the copolymer described herein is reacted with phenol by electrophilic addition via its terminal double bond and the resulting alkylphenol, i.e., copolymer-subsituted phenol, is then reacted with formaldehyde and amine through Mannich reaction to provide 2-aminomethyl-4-alkylphenol. Processes for Mannich-functionalization of a polymer backbone are known in the art, as described in, for example, U.S. Pat. Nos. 2,098,869 and 5,608,029.

Amine or amino compounds useful for the Mannich reaction can be ammonia, alkyl mono-amine, dialkyl mono-amine, or polyamine described above. Unless specified otherwise, the amino groups in the amine compounds can be primary amines, secondary amines, tertiary amines or any mixture thereof as long as the amines contain at least one primary or secondary amine. These amines may be hydrocarbyl amines or may be hydrocarbyl amines including one or more of other groups, e.g., hydroxy, alkoxy, amide, nitrile, imidazoline, and the like. Primary amine-containing compounds refers to amine or amino compounds described above that contain at least one primary amine group, i.e., —NH₂. In addition, the same amines described below that are used to make the amine detergents may also be used to make the Mannich detergents.

Specific examples of suitable Mannich detergents can have, for example, one of the following structures:

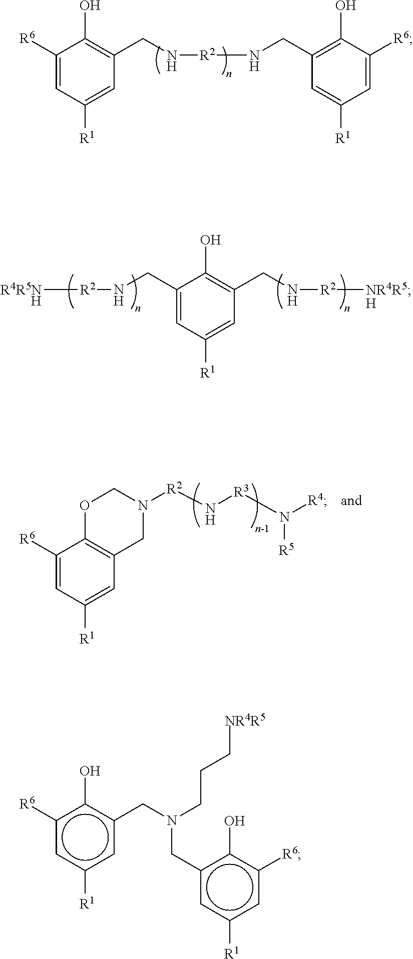

wherein n is 0, 1, 2, 3, 4, 5, 6, 7, or 8; R¹ is an hydrocarbyl radical derived from a copolymer of ethylene and one or more C₃₋₁₀ alpha-olefins; the copolymer has a number average molecular weight of less than 5,000 g/mol as measured by GPC using polystyrene as a calibration reference. The ethylene unit content of the copolymer measured by ¹H-NMR spectroscopy is greater than 40 mol % and less than 90 mol %; a terminal unsaturation of 70 mol % or greater as measured by ¹³C NMR spectroscopy; and at least 70 mol % of the unsaturation is a terminal group having a terminal vinylidene, one or more tri-substituted isomers of the terminal vinylidene and any combination thereof, as measured by ¹H-NMR spectroscopy. The copolymer has an actual average ethylene run length n_{C2,actual}, as measured by ¹³C NMR spectroscopy, of less than 2.6. The copolymer also satisfies the relationship:

n_{C2,Actual}>n_{C2,Statistical}

R² is a divalent C₁-C₆ alkylene; each of R⁴ and R⁵, independently, is H, C₁-C₆ alkyl,

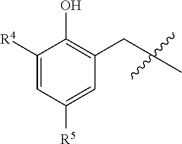

or, together with the N to which they are attached to, form a 5 or 6-membered ring optionally fused with a non-aromatic or an aromatic ring having the following formula

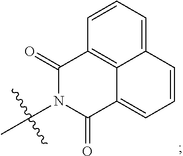 [SMILES: *N1C(=O)c2cccc3cccc(c23)C1=O]

R⁶ is H or C₁-C₆ alkyl, or —CH₂—(NH—R²)ₙ—NR⁴R⁵, or R⁶ may be the same as R¹ or if R¹ and R⁶ are not the same, the positions of R¹ and R⁶ may be switched.

### Amine Detergents

The amine detergents can be selected from compounds of the Formulas (IIIa) and (IIIb):

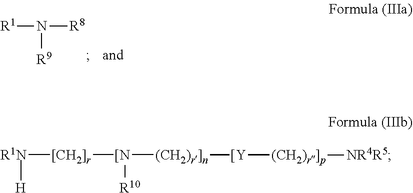

wherein n and p can be the same or different and each of n and p independently is 0, 1, 2, 3, 4, 5, 6, 7, or 8; r, r′, and r″ can be the same or different and each of r, r′, and r″ independently is an integer of from 2 to 6; Y is O or NR¹⁰; R¹ is an hydrocarbyl radical derived from a copolymer of ethylene and one or more C₃₋₁₀ alpha-olefins; the copolymer has a number average molecular weight of less than 5,000 g/mol as measured by GPC using polystyrene as a calibration reference. The ethylene unit content of the copolymer measured by ¹H-NMR spectroscopy is greater than 40 mol % and less than 90 mol %; a terminal unsaturation of 70 mol % or greater as measured by ¹³C NMR spectroscopy; and at least 70 mol % of the unsaturation is a terminal group having a terminal vinylidene, one or more tri-substituted isomers of the terminal vinylidene or any combination thereof, as measured by ¹H-NMR spectroscopy. The copolymer has an actual average ethylene run length n_{C2,Actual}, as measured by ¹³C NMR spectroscopy, of less than 2.6. The copolymer also satisfies the relationship:

n_{C2,Actual}>n_{C2,Statistical}

each of R⁴ and R⁵, independently, is H, C₁-C₆ alkyl,

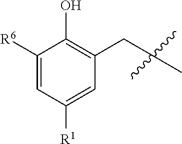

or, together with the N to which they are attached to, form a 5 or 6-membered ring optionally fused with a non-aromatic or an aromatic ring having the following formula

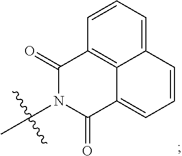 [SMILES: *N1C(=O)c2cccc3cccc(c23)C1=O]

R⁸, R⁹ and R¹⁰ are independently selected from the group consisting of hydrogen, C₁ to C₂₅ straight or branched chain alkyl groups; C₂ to C₁₂ alkoxy C₂ to C₆ alkylene groups; C₂ to C₁₂ hydroxy amino alkylene groups; and C₁ to C₁₂ alkylamino C₂ to C₆ alkylene groups; and wherein R¹⁰ can additionally comprise a group of the formula:

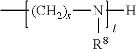

wherein R⁸ is as defined above and wherein s is an integer of from 2 to 6 and t is an integer from 0 to 10.

Referring to Formulae (IIIa) and (IIIb), the amines can be made by the processes described, for example, in U.S. Pat. No. 5,225,092. More specifically, the above-described ethylene-alpha-olefin copolymers may be first halogenated to form halogenated copolymers. The halogenated polymers prepared as described above, can be contacted with one or more amines to detergents of the disclosure. The halogenation-amination reaction involves first halogenation of the terminal double bond of the copolymer, and then reacting the halogen substituted copolymer with amine to provide an amine detergent. See, e.g., U.S. Pat. No. 5,225,092.

In some embodiments, a derivatized copolymer is prepared by a process comprising: (1) reacting an ethylene-C₃-C₁₀ alpha olefin copolymer described herein with a halogenating agent for form a halogen-containing copolymer; and (2) coupling the halogen-containing copolymer of step (1) with an amine compound.

In some embodiments, a derivatized copolymer is prepared by a process comprising: reacting an alkylphenol, an aldehyde, and an amine compound, wherein the alkylphenol is prepared from a substituted or unsubstituted hydroxyaromatic compound and an ethylene-C₃-C₁₀ alpha olefin copolymer described herein.

The hydroformylation-reductive-amination reaction involves reacting an aldehyde or ketone with an amino compound under condensation conditions sufficient to give an imine intermediate, which is subsequently reacted under hydrogenation conditions sufficient to give an amine detergent. In some embodiments of this invention, the copolymer having terminal double bond described herein is converted to an aldehyde or ketone by hydroformylation of the terminal double bond. The resulting aldehyde or ketone may be reacted with amine under reductive amination reaction condition to provide a detergent. Processes for hydroformylation and reductive amination reaction are known in the art, as described in, for example, US 2014/0087985.

In some embodiments, a derivatized copolymer is prepared by a process comprising: (1) hydroformylating an ethylene-C₃-C₁₀ alpha olefin copolymer described above to form a copolymer having a terminal aldehyde moiety; and (2) reacting the copolymer prepared by step (1) with an amine compound under reductive condition.

Amine or amino compounds useful for hydroformylation-reductive-amination reaction, and halogenation-amination reaction can be ammonia, alkyl mono-amine, dialkyl mono-amine, or polyamine described above. Unless specified otherwise, the amino groups in the amine compounds can be primary amines, secondary amines, tertiary amines or any mixture thereof. These amines may be hydrocarbyl amines or may be hydrocarbyl amines including one or more of other groups, e.g., hydroxy, alkoxy, amide, nitrile, imidazoline, and the like. Primary amine-containing compounds refers to amine or amino compounds described above that contain at least one primary amine group, i.e., —NH₂.

The amine compounds may include mono- and (preferably) polyamines, of about 2 to 60, preferably about 2 to 40, or about 3 to 20, total carbon atoms and about 1 to 12, preferably 3 to 12, and most preferably 3 to 9 nitrogen atoms in the molecule. These amines may be hydrocarbyl amines or may be hydrocarbyl amines including other groups, e.g, hydroxy groups, alkoxy groups, amide groups, nitriles, imidazoline groups, and the like. Hydroxy amines with 1 to 6 hydroxy groups, preferably 1 to 3 hydroxy groups are particularly useful. Preferred amines are aliphatic saturated amines, including those of the general Formulas (VIIa) and (VIIb):

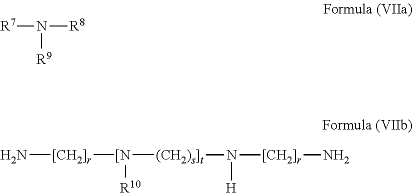

wherein R⁷, R⁸, R⁹ and R¹⁰ are independently selected from the group consisting of hydrogen; C₁ to C₂₅ straight or branched chain alkyl radicals; C₁ to C₁₂ alkoxy C₂ to C₆ alkylene radicals; C₂ to C₁₂ hydroxy amino alkylene radicals; and C₁ to C₁₂ alkylamino C₂ to C₆ alkylene radicals; and wherein R¹⁰ can additionally comprise a moiety of the Formula:

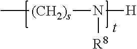

wherein R⁸ is as defined above, and wherein s is an integer of from 2 to 6 and t is an integer from 0 to 10. R⁷, R⁸, R⁹, R¹⁰, r, and t be selected in a manner sufficient to provide the compounds of Formulas (VIIa) and (VIIb) with typically at least one primary or secondary amine group, preferably at least two primary or secondary amine groups. Amines of the Formula (VIIb) are advantageous when they contain at least two primary amine groups and at least one, and preferably at least three, secondary amine groups.

Non-limiting examples of suitable amine compounds include: 1,2-diaminoethane; 1,3-diaminopropane; 1,4-diaminobutane; 1,6-diaminohexane; polyethylene amines such as diethylene triamine; triethylene tetramine; tetraethylene pentamine; polypropylene amines such as 1,2-propylene diamine; di-(1,2-propylene)triamine; di-(1,3-propylene) triamine; N,N-dimethyl-1,3-diaminopropane; N,N-di-(2-aminoethyl) ethylene diamine; N,N-di(2-hydroxyethyl)-1,3-propylene diamine; 3-dodecyloxypropylamine; N-dodecyl-1,3-propane diamine; tris hydroxymethylaminomethane (THAM); diisopropanol amine: diethanol amine; triethanol amine; mono-, di-, and tri-tallow amines; amino morpholines such as N-(3-aminopropyl)morpholine; and mixtures thereof.

Other useful amine compounds include: alicyclic diamines such as 1,4-di(aminomethyl) cyclohexane, and heterocyclic nitrogen compounds such as imidazolines, and N-aminoalkyl piperazines of the general Formula (VIII):

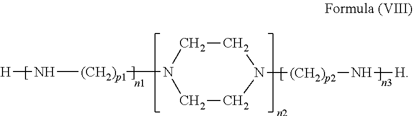

wherein p₁ and p₂ are the same or different and are each integers of from 1 to 4, and n₁, n₂ and n₃ are the same or different and are each integers of from 1 to 3. Non-limiting examples of such amines include 2-pentadecy imidazoline; N-(2-aminoethyl) piperazine; etc.

Commercial mixtures of amine compounds may advantageously be used. For example, one process for preparing alkylene amines involves the reaction of an alkylene dihalide (such as ethylene dichloride or propylene dichloride) with ammonia, which results in a complex mixture of alkylene amines wherein pairs of nitrogens are joined by alkylene groups, forming such compounds as diethylene triamine, triethylenetetramine, tetraethylene pentamine and isomeric piperazines. Low cost poly(ethyleneamines) compounds averaging about 5 to 7 nitrogen atoms per molecule are available commercially under trade names such as “Polyamine H”, “Polyamine 400”, “Dow Polyamine E-100”, etc.

Other exemplary suitable amines include amines of the formula:

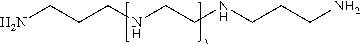

wherein x is an integer of from 0 to 3, and an amine of the formula:

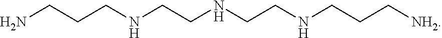 [SMILES: NCCCNCCNCCNCCCN]

Useful amines also include polyoxyalkylene polyamines such as those of the Formula (IX):

NH₂-alkyleneO-alkyleneₘNH₂ Formula (IX)

where m has a value of about 3 to 70 and preferably 10 to 35; and amines of the Formula (X):

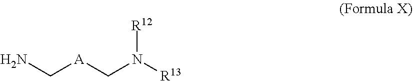

wherein A is a hydrocarbyl linker with 2 to 10 carbon units and including one or more carbon units thereof independently replaced with a bivalent moiety selected from the group consisting of —O—, —N(R¹⁴)—, —C(O)—, —C(O)O—, —C(O)NR¹⁴; R¹² and R¹³ are independently alkyl groups containing 1 to 8 carbon atoms; and R¹⁴ is independently a hydrogen or a group selected from C₁₋₆ aliphatic, phenyl, or alkylphenyl.

The polyoxyalkylene polyamines of Formulas (IX) or (X) above, preferably polyoxyalkylene diamines and polyoxyalkylene triamines, may have average molecular weights ranging from about 200 to about 4000 and preferably from about 400 to about 2000. The preferred polyoxyalkylene polyoxyalkylene polyamines include the polyoxyethylene and polyoxypropylene diamines and the polyoxypropylene triamines having average molecular weights ranging from about 200 to 2000. The polyoxyalkylene polyamines are commercially available and may be obtained, for example, from the Jefferson Chemical Company, Inc. under the trade name “Jeffamines D-230, D-400, D-1000, D-2000, T-403”, etc.

The polyamine reactant may contain at least one primary amine (and more preferably from 2 to 4 primary amines) group per molecule, and the polyamine and the ethylene-alpha olefin copolymer are contacted in an amount of from about 1 to 10, more preferably from about 2 to 6, and most preferably from about 3 to 5, equivalents of primary amine in the polyamine reactant per mole of the ethylene-alpha olefin copolymer.

The amino-group containing detergents can be made, for example, as described in U.S. Pat. No. 5,225,092.

### Optional Fuel Additives

One or more additional optional compounds may be present in the fuel compositions of the disclosed embodiments. For example, the fuels may contain conventional quantities of optional compounds including, but not limited to, cetane improvers, octane improvers, corrosion inhibitors, cold flow improvers (CFPP additive), cold starting aids, pour point depressants, solvents, demulsifiers, lubricity additives, friction modifiers, amine stabilizers, combustion improvers, supplemental detergents, dispersants, antioxidants, heat stabilizers, conductivity improvers, metal deactivators, marker dyes, emission control additives, organic nitrate ignition accelerators, metallic combustion improvers, cyclopentadienyl manganese tricarbonyl compounds such as mnethylcyciopentadienyl manganese tricarbonyi, carrier fluids, and the like.

Various compounds known for use as oxidation inhibitors can be utilized in the practice of this invention. These include phenolic antioxidants, amine anti-oxidants, sulfurized phenolic compounds, and organic phosphites, among others. For best results, the antioxidant should be composed predominantly or entirely of either (1) a hindered phenol antioxidant such as 2-tert-butylphenol. 2,6-di-tert-butylphenol,2,4,6-tri-tert-butylphenol,4-methyl-2,6-di-tert-butylphenol, 4,4′-methylenebis(2,6-di-tert-butylphenol), and mixed methylene bridged polyalkyl phenols, or (2) an aromatic amine antioxidant such as the cycloalkyldi-lower alkyl amines, and phenylenediamines, or a combination of one or more such phenolic antioxidants with one or more such amine antioxidants. Particularly preferred for use in the practice of this invention are tertiary butyl phenols, such as 2,6-di-tert-butylphenol, 2,4,6-tri-tert-butylphenol, o-tert-butylphenol, and mixtures thereof.

A wide variety of demulsifiers are available for use in the practice of this invention, including, for example, poly(oxyalkylene) glycols, oxyalkylated phenolic resins, and like materials. Particularly preferred are mixtures of poly(oxyalkylene) glycols and oxyalkylated alkylphenolic resins, such as are available commercially from Petrolite Corporation under the TOLAD trademark. One such proprietary product, identified as TOLAD 9308, is understood to be a mixture of these components dissolved in a solvent composed of heavy aromatic naphtha and isopropanol. This product has been bound efficacious for use in the compositions of this invention. However, other known demulsifiers can be used such as TOLAD 286.

Here again, a variety of materials are available for use as corrosion inhibitors in the practice of this invention. Thus, use can be made of dimer and trimer acids, such as are produced from tall oil fatty acids, oleic acid, linoleic acid, or the like. Products of this type are currently available from various commercial sources, such as, for example, the dimer and trimer acids sold under the HYSTRENE trademark by the Humko Chemical Division of Witco Chemical Corporation and under the EMPOL trademark by Emery Chemicals. Another useful type of corrosion inhibitor for use in the practice of this invention are the alkenyl succinic acid and alkenyl succinic anhydride corrosion inhibitors such as, for example, tetrapropenylsuccinic acid, tetrapropenylsuccinic anhydride, tetradecenylsuccinic acid, tetradecenylsuccinic anhydride, hexadecenylsuccinic acid, hexadecenylsuccinic anhydride, and the like. Also useful are the half esters of alkenyl succinic acids having 8 to 24 carbon atoms in the alkenyl group with alcohols such as the polyglycols. Also useful are the aminosuccinic acids or derivatives thereof. Most preferred is a tetralkenyl succinic acid such as a tetrapropenyl succinic acid.

Optional additional detergents include other succinimide detergents, other Mannich detergents and other alkyl amine detergents, particularly those substituted with polyisobutenyl (PIB) groups.

Another optional detergent that can be added is a quaternary ammonium salts comprising the reaction product of:

(i) at least one compound selected from the group consisting of:
(a) the condensation product of an acylating agent substituted with at least one group R¹ and a compound having an oxygen or nitrogen atom capable of condensing with said acylating agent and said condensation product further having a tertiary amino group;
(b) an amine substituted with at least one group R¹ and having at least one tertiary amino group; and
(c) a Mannich reaction product having a tertiary amino group, said Mannich reaction product being prepared from the reaction of a phenol substituted with at least one group R¹, an aldehyde, and an amine; and

(ii) a quaternizing agent suitable for converting the tertiary amino group of compound (i) to a quaternary nitrogen, wherein the quaternizing agent is an alkylphenol agent for example dialkyl sulfates, benzyl halides, hydrocarbyl substituted carbonates; hydrocarbyl epoxides in combination with an acid or mixtures thereof.

Examples of typical quaternary ammonium salts and methods for preparing the same are described in the following patents, U.S. Pat. Nos. 4,253,980, 3,778,371, 4,171,959, 4,326,973, 4,338,206, and 5,254,138.

The additive compositions are typically employed in hydrocarbon mixtures in the gasoline boiling range or hydrocarbon/oxygenate mixtures, or oxygenates, but are also suitable for use in middle distillate fuels, notably, diesel fuels and fuels for gas turbine engines. The nature of such fuels is well known to those skilled in the art. By oxygenates is meant alkanols and ethers such as methanol, ethanol, propanol, methyl-tert-butyl ether, ethyl-tert-butyl ether, tert-amyl-methyl ether and the like, or combinations thereof.

In the present application, the concentration of certain additives are referred to in terms of pounds per thousand barrels (ptb). One pound per thousand barrels of additive in a gasoline of typical specific gravity is generally equivalent to about 3.8 to about 4.0 parts per million (ppm) on a weight basis. This assumes a 0.75 g/ml specific gravity of the fuel measured at 15.6° C. Diesel fuel typically has a 0.832 g/ml specific gravity and thus a skilled person can calculate ppm on a weight basis from ptb.

In some aspects, the compositions described herein may contain about 10 weight percent or less, or in other aspects, about 5 weight percent or less, based on the total weight of the additive concentrate, of one or more of the above additives. Similarly, the fuels may contain suitable amounts of conventional fuel blending components such as methanol, ethanol, dialkyl ethers, 2-ethylhexanol, and the like.

When formulating the fuel compositions of this application, the additives may be employed in amounts sufficient to reduce or inhibit deposit formation in a fuel system or combustion chamber of an engine and/or crankcase. In some aspects, the fuels may contain minor amounts of the above described reaction product that controls or reduces the formation of engine deposits, for example injector deposits in engines. The active ingredient basis excludes the weight of (i) unreacted components associated with and remaining in the product as produced and used, and (ii) solvent(s), if any, used in the manufacture of the product either during or after its formation.

The additives of the present application and optional additives used in formulating the fuels of this invention may be blended into the base fuel individually or in various sub-combinations. In some embodiments, the additive components of the present application may be blended into the fuel concurrently using an additive concentrate, as this takes advantage of the mutual compatibility and convenience afforded by the combination of ingredients when in the form of an additive concentrate. Also, use of a concentrate may reduce blending time and lessen the possibility of blending errors.

### Fuel Compositions

The fuels of the present application may be applicable to the operation of diesel, or gasoline engines. The engine include both stationary engines (e.g., engines used in electrical power generation installations, in pumping stations, etc.) and ambulatory engines (e.g., engines used as prime movers in automobiles, trucks, road-grading equipment, military vehicles, etc.). The fuel compositions of the present invention are particularly suitable for compression and spark ignition engines.

The fuels may include any and all middle distillate fuels, diesel fuels, biorenewable fuels, biodiesel fuel, fatty acid alkyl ester, gas-to-liquid (GTL) fuels, gasoline, jet fuel, alcohols, ethers, kerosene, low sulfur fuels, synthetic fuels, such as Fischer-Tropsch fuels, liquid petroleum gas, bunker oils, coal to liquid (CTL) fuels, biomass to liquid (BTL) fuels, high asphaltene fuels, fuels derived from coal (natural, cleaned, and petcoke), genetically engineered biofuels and crops and extracts therefrom, and natural gas. “Biorenewable fuels” as used herein is understood to mean any fuel which is derived from resources other than petroleum. Such resources include, but are not limited to, corn, maize, soybeans and other crops; grasses, such as switchgrass, miscanthus, and hybrid grasses; algae, seaweed, vegetable oils; natural fats; and mixtures thereof. In an aspect, the biorenewable fuel can comprise monohydroxy alcohols, such as those comprising from 1 to about 5 carbon atoms. Non-limiting examples of suitable monohydroxy alcohols include methanol, ethanol, propanol, n-butanol, isobutanol, t-butyl alcohol, amyl alcohol, and isoamyl alcohol.

Diesel fuels that may be used include low sulfur diesel fuels and ultra low sulfur diesel fuels. A “low sulfur” diesel fuel means a fuel having a sulfur content of 50 ppm by weight or less based on a total weight of the fuel. An “ultra-low sulfur” diesel fuel (ULSD) means a fuel having a sulfur content of 15 ppm by weight or less based on a total weight of the fuel.

In some embodiments, the fuels may be or contain biofuels including, for example, biodiesel fuel. In another embodiment, the diesel fuels are substantially devoid of biodiesel fuel components.

Another aspect of the present application is directed to methods for operating an internal combustion engine by combusting the fuel composition of the disclosure in the internal combustion engine during the engine's operation. The engine can be a diesel engine and the fuel composition is a diesel fuel composition. Alternatively, the engine is a gasoline engine and the fuel composition is a gasoline fuel composition.

Another aspect of the present application is directed to a method for reducing injector valve deposits in a gasoline internal combustion engine by combusting the gasoline fuel composition of the present disclosure in the gasoline internal combustion engine during the engine's operation.

Another aspect of the present application is directed to a method for reducing valve sticking in a gasoline internal combustion engine by combusting the gasoline fuel composition of the present disclosure in the gasoline internal combustion engine during the engine's operation. The gasoline engine may be a direct injected gasoline engine.

Another aspect of the present application is directed to a method for stabilizing a diesel fuel composition comprising gasoline by combining with said diesel fuel composition the detergent additive of the present disclosure.

Another aspect of the present application is directed to a method for reducing injector nozzle fouling in a diesel internal combustion engine by combusting the diesel fuel composition of the present disclosure in the diesel internal combustion engine during the engine's operation.

Other aspects of the present application are directed to uses of the gasoline fuel composition for reducing injector valve deposits in a gasoline internal combustion engine and/or for reducing valve sticking in a gasoline internal combustion engine. The gasoline engine may be a direct injected engine.

Another aspect of the present application is directed to uses of the detergent of the present disclosure for stabilizing a diesel fuel composition.

Other aspects of the present application are directed to uses of the diesel fuel composition of the present disclosure for reducing or preventing injector nozzle clogging in a fuel injected diesel internal combustion engine.

In some aspects, the fuel compositions of the present invention may provide friction reduction and/or an improvement in the low temperature viscosity of the fuel compositions at temperatures from −30° C. to 40° C.

In some aspects, the methods and uses comprise injecting a hydrocarbon-based fuel comprising a detergent of the present disclosure through the injectors of the engine into the combustion chamber, and igniting the fuel. In some aspects, the method may also comprise mixing into the fuel at least one of the optional additional ingredients described above.

### EXAMPLES

The following examples are illustrative of exemplary embodiments of the disclosure. In these examples as well as elsewhere in this application, all parts and percentages are by weight unless otherwise indicated. It is intended that these examples are being presented for the purpose of illustration only and are not intended to limit the scope of the invention disclosed herein.

### Synthesis:

### Succinimide Detergent)

Ethylene propylene copolymer (containing 49 mol % ethylene content and Mn being 1050) 168.5 g (0.16 mol) and maleic anhydride 23.5 g (0.24 mol) were charged to 350 mL PARR pressure reactor equipped with a stirrer and a thermocouple. The reaction mixture was heated to 50 C, purged with nitrogen for 15 min with stirring. The reactor temperature was raised to 235 C and maintained at that temperature for 6 h while stirring. The reaction mixture was then cooled to 90 C and transferred to a 500 mL round bottom flask. The reaction mixture was then heated and the unreacted maleic anhydride was removed in vacuo. Analytical analysis: 1.2 SA/Olefin (acid number 0.966) and 91.0% functionalized polymer.

The alkyl succiminic anhydride (ASA) obtained above 70.1 g (0.068 mol) was charged to a 250 mL round bottom 3-Neck flask equipped with an overhead stirrer, Dean-Stark trap and condenser. The ASA was stirred and heated to 160 C under nitrogen. Triethylene pentamine 8.48 g (0.024 mol) was added drop wise via an addition funnel. The reaction mixture was stirred with heating under a vacuum for 3 h. At that time 19.3 g Aromatic 150 was added and filtered in a pressure filter to afford a succinimide product.

### Mannich Detergent

To a 4-neck 1000 mL round bottomed flask was added cresol (53.49 g, 494.64 mmol) followed by n-heptane (20 g). The flask was equipped with mechanical stirrer, thermocouple, nitrogen inlet, stopper and a 50 C water bath. While warming, stirring was begun and the flask was briefly flushed with nitrogen. Boron trifluoride diethyl etherate (BF₃.OEt₂, 5.26 g, 37.09 mmol) was added drop wise and the resulting complex mixture was allowed to warm to 50 C over about 20 minutes. Positive nitrogen pressure was increased and the stopper was removed. The ethylene-propylene copolymer (46 mol % ethylene, Mn 780) (206.65 g, 264.9 mmol) was added over about 3-4 minutes. The stopper was replaced, positive nitrogen pressure was reduced, and the reaction was stirred 4 hours at 50° C.

The catalyst was quenched by sub-surface bubbling of ammonia gas in to the reaction solution. Ammonia bubbling was continued for another 1-2 minutes after the reaction solution changed to a yellow/beige color. The crude reaction mixture was transferred to a 2000 mL Erlenmeyer flask diluted with 400 mL n-heptane and 230 mL ethyl acetate. The solution was suction filtered through a small pad of Celite 512 over a fiberglass filter paper in to a 2000 mL round bottomed flask. The solvents were removed in vacuo. Kugelrohr bulb-to-bulb distillation apparatus was used to remove the excess cresol resulting in 232.1 g (98.6%) of the desired para-substituted cresol.

To a 4-neck 1000 mL round bottomed flask was added the alkyl cresol described above (101.17 g, 107.63 mmol), toluene (57.6 g), dibutylamine (14.66 g, 113.44 mmol), and 37% aq. formaldehyde (9.29 g solution, 113.2 mmol). The flask was equipped with mechanical stirrer, temperature controller (thermocouple & heating mantle), nitrogen inlet, and Dean-Stark trap equipped with a condenser. The reaction was stirred and heated under a stream of nitrogen. The reaction temperature was gradually increased up to 142 C over 5-6 h. The reaction mixture was concentrated in vacuo affording 114.57 g (97.8%) of the desired Mannich product.

### Example 1—Valve Sticking Test

A valve sticking test that simulates the Wasserboxer valve sticking test (CEC F 16-T-96) and gives similar results was conducted. A sample was placed on a valve and allowed to cool. The pressure to move the valve after the sample had been allowed to sit on the valve was measured. The lower the pressure the better the valve sticking performance. Pure polymers were used in this test.

A 950 MW polyisobutylene (PIB) required 34,000 lbs*sec to move the stuck valve. A variety of different ethylene-alpha-olefin copolymers required significantly lower pressures to move the stuck valve as shown in Table 3 below.

TABLE 3

| | | | Pressure |
|---|---|---|---|
| | | Number Average | Required |
| | | Molecular Weight | to Move |
| Test | | (Mn) of the | the Valve |
| No. | (Co)polymer | (Co)polymer (GPC) | (lbs * sec) |
| C1 | Polyisobutylene | 1191 | 34,000 |
| 1 | Ethylene-propylene copolymer | 1365 | 8,300 |
| | containing 46 mole % ethylene | | |
| 2 | Ethylene-butylene copolymer | 1316 | 6,500 |
| | containing 69 mole % ethylene | | |
| 3 | Ethylene-hexylene copolymer | 1203 | 6,630 |
| | containing 56 mole % ethylene | | |
| 4 | Ethylene-octylene copolymer | 1033 | 2,740 |
| | containing 86 mole % ethylene | | |

The difference in behavior between the ethylene-alpha olefin copolymers in comparison to the polyisobutylene copolymer is related to the low temperature kinematic viscosity of the copolymers (i.e. at −30° C. to 40° C.).

### Example 2—Kinematic Viscosity of the Dispersants at 40° C.

The kinematic viscosities of polyisobutylene polymer and pure detergents were measured at 40° C. was measured using a Stabinger viscometer (Anton Paar). The results are given in Table 4 below.

TABLE 4

| | | Number | |
|---|---|---|---|
| | | Average | |
| | | Molecular | |
| | | Weight (Mn) of | Kinematic |
| | | the | Viscosity |
| Test | | (Co)polymer | at 40° C. |
| No. | Polymer or Dispersant | (GPC) | (mm²/sec) |
| C2 | Polyisobutylene | 1191 | 4383 |
| C3 | Polyisobutylene phenol | 1191 | >30,000 |
| C4 | Polyisobutylene dibutylamine | 1191 | >30,000 |
| | phenol Mannich detergent | | |
| 5 | Ethylene-propylene copolymer | 1673 | 367.3 |
| | (51 mol % ethylene) | | |
| 6 | Ethylene-propylene copolymer | 1355 | 161.4 |
| | (48 mol % ethylene) | | |
| 7 | Ethylene-propylene copolymer | 1051 | 66.1 |
| | (53 mol % ethylene) | | |
| 8 | Ethylene-propylene copolymer | 1673 | 2,181 |
| | (51 mol % ethylene) | | |
| | phenol | | |
| 9 | Ethylene-propylene copolymer | 1355 | 1,447 |
| | (48 mol % ethylene) | | |
| | phenol | | |
| 10 | Ethylene-propylene copolymer | 1051 | 941 and 948* |
| | (53 mol % ethylene) | | |
| | phenol | | |
| 11 | Ethylene-propylene copolymer | 1355 | 868 and 875* |
| | (48 mol % ethylene) | | |
| | dibutylamine phenol Mannich | | |
| | detergent | | |

*indicates that the measurement was repeated.

### Example 3—Ford 2.3 L Intake Valve Deposits

In the Ford 2.3 L Intake Valve Deposit (IVD) test (ASTM-6201), a reference base fuel (Citgo RUL (E10) R14012815) without the detergent additive had an IVD result of 755 mg/valve. Additive compositions including a cresol Mannich detergent made with di-butyl amine (DBA) and three different ethylene-alpha-olefin copolymers were added to the reference base fuel at a treat rate of 62 PTB Package (20.7 PTB Mannich/10.3 PTB Polyol Carrier/31 PTB Aromatic 100 solvent).

When the cresol Mannich detergents derived from ethylene-alpha copolymers were added to the reference base fuel, the IVD results improved significantly, as shown in Table 5 below.

TABLE 5

| | | Number Average | |
|---|---|---|---|
| | | Molecular Weight | |
| | | (Mn) of the | Intakc |
| | Ethylene-Alpha Olefin Copolymer | Ethylene-Alpha- | Valve |
| Test | Used to Make the Cresol Mannich | Olefin Copolymer | Deposits |
| No. | Detergent | (GPC) | (mg/valve) |
| C5 | No Copolymer - Reference | N/A | 755 |
| | Base Fuel Citgo RUL (E10) | | |
| | R17012030 Only | | |
| 12 | Ethylene-propylene copolymer | 1365 | 418 |
| | (46 mol % ethylene) | | |
| 13 | Ethylene-butylene copolymer | 1316 | 495 |
| | (69 mol % ethylene) | | |
| 14 | Ethylene-octylene copolymer | 1033 | 455 |
| | (86 mol % ethylene) | | |

### Example 4—Mannich Detergent Intake Valve Deposits

An intake valve deposits screening test was carried out by SWRI using their Intake Valve Depository Apparatus at 204° C. for 20 hours. The reference base fuel (Citgo RUL (E10) R17012030) used in this test produced 14.3 mg of deposits. Three different phenol Mannich detergents made with di-methyl aminopropyl amine (DMAPA) and the ethylene-alpha-olefin copolymers shown in Table 5 below were added to the reference base fuel at a treat rate of 100 PTB Package (33.3 PTB Mannich/16.7 PTB Polyol Carrier/50 PTB Aromatic 100 solvent). The addition of ethylene-alpha-olefin-based phenol Mannich detergents reduced the amount of deposits as shown in Table 6 below.

TABLE 6

| | | Number Average | |
|---|---|---|---|
| | | Molecular Weight | |
| | | (Mn) of the | Intakc |
| | Ethylene-Alpha Olefin Copolymer | Ethylene-Alpha- | Valve |
| Test | Used to Make the Phenol Mannich | Olefin Copolymer | Deposits |
| No. | Detergent | (GPC) | (mg) |
| C6 | No Copolymer Reference Base | N/A | 14.3 |
| | Fuel Citgo RUL (E10) | | |
| | R17012030 Only | | |
| 15 | Ethylene-propylene copolymer | 1051 | 10.3 |
| | (53 mol % ethylene) | | |
| 16 | Ethylene-propylene copolymer | 1355 | 7.8 |
| | (48 mol % ethylene) | | |
| 17 | Ethylene-propylene copolymer | 1675 | 7.9 |
| | (51 mol % ethylene) | | |

### Example 5—Polymer Amine Detergent Intake Valve Deposits

Example 5 employed the same test method and fuel as was used in Example 4 above. A polymer amine detergent was made from an amine obtained by hydroformylation followed by reductive amination with NH₃. The additive was employed at a treat rate if 100 PTB package (33.3 PTB Polymer amine/16.7 PTB Polyol Carrier/50 PTB Aromatic 100 solvent). The results are given in Table 7 below.

TABLE 7

| | | Number Average | Intakc |
|---|---|---|---|
| | | Molecular Weight | Valve |
| Test | (Co)polymer Used to Make the | (Mn) of the | Deposits |
| No. | Phenol Mannich Detergent | (Co)polymer (GPC) | (mg) |
| C7 | No Copolymer Reference Base | N/A | 14.3 |
| | Fuel Citgo RUL (E10) | | |
| | R17012030 Only | | |
| 18 | Ethylene-propylene copolymer | 1340 | 12.1 |
| | (41 mol % ethylene) | | |
| C8 | polyisobutylene | 1191 | 11.4 |

### Example 6—PAD Fuel Stability/Dispersancy

A PAD fuel stability/dispersancy test (ASTM D6468) was used wherein fuels containing diesel additives were degraded on a surface. Light was then reflected off the surface and the % reflected light (% reflectance) was measured. The higher the % reflectance, the better the diesel additive prevents fuel degradation.

A base fuel without any additive formed a deposit on the surface and the measured % reflectance was 16.4%. Adding detergents derived from ethylene-alpha-olefin copolymers to this base fuel improved the stability of the fuel as shown by the increase in % reflectance in the PAD test shown in Table 8 below.

TABLE 8

| | | Number Average | | |
|---|---|---|---|---|
| | | Molecular Weight | | |
| | | (Mn) of the | | PAD |
| | The Succinimide | (Co)polymer | Treat Rate | Reflectance |
| Test No. | Detergent | (GPC) | (ppmw) | (%) |
| C9 | No Copolymer - Reference | N/A | 0 | 16.4 |
| | Base Fuel Citgo RUL | | | |
| | (E10) R17012030 Only | | | |
| 19 | Ethylene-Propylene | <3000 | 50 | 28.1 |
| | SA:Olefin Ratio 1:1 | | | |
| | SA:Polyamine Ratio 2.3:1 | | | |
| 20 | Ethylene-Propylene | <3000 | 100 | 30.5 |
| | SA:Olefin Ratio 1:1 | | | |
| | SA:Polyamine Ratio 2.3:1 | | | |
| 21 | Ethylene-Propylene | <3000 | 150 | 30.5 |
| | SA:Olefin Ratio 1:1 | | | |
| | SA:Polyamine Ratio 2.3:1 | | | |
| 22 | Ethylene-Propylene | <3000 | 150 | 64.5 |
| | SA:Olefin Ratio 1:2 | | | |
| | SA:Polyamine Ratio 1.5:1 | | | |
| 23 | Ethylene-Propylene | <3000 | 150 | 65.3 |
| | SA:Olefin Ratio 1:2 | | | |
| | SA:Polyamine Ratio 1.5:1 | | | |

SA refers to succinic anhydride.

Comparative Test C9 is a reference example to provide a baseline % reflectance that results from the base fuel without additives. Tests 19-23 show that the succinimide detergents prepared from the ethylene-propylene copolymers, maleic anhydride, and TEPA provide a significantly improved % reflectance when added to the base fuel Tests 22 and 23 were repeated to confirm that consistent test results are obtained when the test is repeated.

### Example 7—XUD-9 Engine Test of Percent Injector Fouling (CEC F-23-01)

An XUD-9 Engine Test was conducted according to the procedure of CEC F-23-01 to measure percent injector fouling. The base fuel without additive showed 75% injector fouling upon completion of the test. When added to the same base fuel at a treat rate of 150 ppmw, the ethylene-propylene copolymer with a number average molecular weight Mn of 1038 as measured by ¹H-NMR, an SA:olefin ratio of 1:2 and an SA:polyamine (TEPA) ratio of 1.5 significantly reduced the injector fouling to 23%.

It is noted that, as used in this specification and the appended claims, the singular forms “a,” “an,” and “the,” include plural referents unless expressly and unequivocally limited to one referent. Thus, for example, reference to “an antioxidant” includes two or more different antioxidants. As used herein, the term “include” and its grammatical variants are intended to be non-limiting, such that recitation of items in a list is not to the exclusion of other like items that can be substituted or added to the listed items

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the disclosure being indicated by the following claims.

All patents and publications cited herein are fully incorporated by reference herein in their entirety, or least for the specific information referenced in the present application in relation to the particular patent or publication. In addition, International PCT application no. PCT/US2017/065767 filed on 12 Dec. 2017 is incorporated by reference herein in its entirety.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A fuel composition comprising a fuel and a fuel additive, said fuel additive comprising:
a fuel soluble detergent selected from compounds of the Formulae (I), (IIa), (IIIa) and (IIIb): 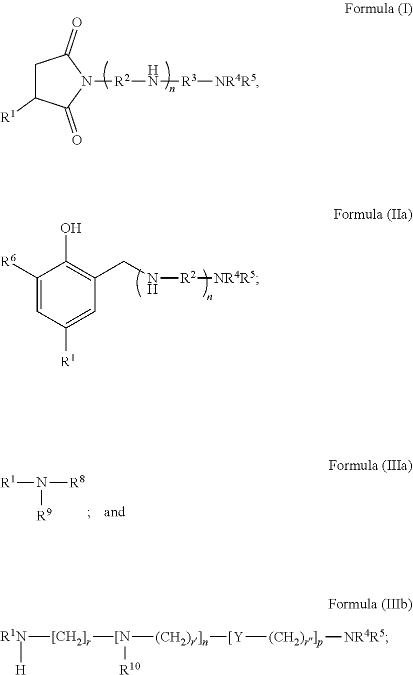
wherein n and p can be the same or different and each of n and p independently is 0, 1, 2, 3, 4, 5, 6, 7, or 8; r, r′, and r″ can be the same or different and each of r, r′, and r″ independently is an integer of from 2 to 6; Y is O or NR¹⁰; R¹ is an hydrocarbyl radical derived from a copolymer of ethylene and one or more C₃₋₁₀ alpha-olefins;
the copolymer has a number average molecular weight of less than 5,000 g/mol as measured by GPC using polystyrene as a calibration reference;
the ethylene unit content of the copolymer measured by ¹H-NMR spectroscopy is greater than 40 mol % and less than 90 mol %;
the copolymer has a terminal unsaturation of 70 mol % or greater as measured by ¹³C NMR spectroscopy; and
at least 70 mol % of the unsaturation is terminal vinylidene, one or more tri-substituted isomers of the terminal vinylidene or any combination thereof, as measured by ¹H-NMR spectroscopy;
the copolymer has an average ethylene run length n_{C2,Actual}, as measured by ¹³C NMR spectroscopy, of less than 2.6; and wherein:
n_{C2,Actual}>n_{C2,Statistical};
R² and R³ are each independently selected from a divalent C₁-C₆ alkylene; each of R⁴ and R⁵, independently, is H, C₁-C₆ alkyl, 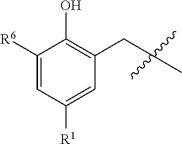
or, together with the N to which they are attached to, form a 5 or 6-membered ring optionally fused with a non-aromatic or an aromatic ring having the following formula 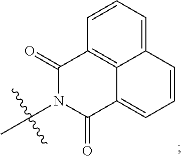 [SMILES: *N1C(=O)c2cccc3cccc(c23)C1=O]
R⁶ is H or C₁-C₆ alkyl, or —CH₂—(NH—R²)ₙ—NR⁴R⁵, or R⁶ may be the same as R¹ or if R¹ and R⁶ are not the same, the positions of R¹ and R⁶ may be switched; R⁷, R⁸, R⁹ and R¹⁰ are independently selected from the group consisting of hydrogen, C₁ to C₂₅ straight or branched chain alkyl groups; C₂ to C₁₂ alkoxy C₂ to C₆ alkylene groups; C₂ to C₁₂ hydroxy amino alkylene groups; and C₁ to C₁₂ alkylamino C₂ to C₆ alkylene groups; and wherein R¹⁰ can additionally comprise a group of the formula: 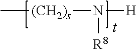
wherein R⁸ is as defined above and wherein s is an integer of from 2 to 6 and t is an integer from 0 to 10.

2. The fuel composition of claim 1, wherein the fuel composition contains from 10 to 500 ppmw (2.5 to 132 ptb) of the fuel soluble detergent.

3. The fuel composition of claim 1, wherein n is from 3-6.

4. The fuel composition of claim 1, wherein the detergent is a detergent of the Formula (I).

5. The fuel composition of claim 4, wherein the detergent is a reaction product prepared by reaction of an amine-containing compound ethylene-propylene copolymer-substituted succinic anhydride obtained by reacting an ethylene-propylene copolymer with maleic anhydride, wherein the molar ratio of the maleic anhydride to the copolymer is from 1:1 to 2:1; and the molar ratio of the copolymer-substituted succinic anhydride to the amine-containing compound is from 1:1 to 3:1.

6. The fuel composition of claim 1, wherein the detergent is a detergent of the formulae (IIa).

7. The fuel composition of claim 1, wherein the detergent is a detergent of the formulae (IIIa) and (IIIb).

8. The fuel composition of claim 1, further comprising one or more additional fuel additives selected from the group consisting of cetane improvers, octane improvers, friction modifiers, cloud point depressants, pour point depressants, demulsifiers, flow improvers, antistatic agents, other detergents, antioxidants, antifoams, corrosion/rust inhibitors, extreme pressure/antiwear agents, seal swell agents, lubricity agent, antimisting agents, and mixtures thereof.

9. The fuel composition of claim 8, wherein the additional fuel additive is a friction modifier and/or a lubricity agent.

10. The fuel composition of claim 1, wherein the copolymer has a crossover temperature of −25° C. or lower.

11. The fuel composition of claim 1, wherein the ethylene unit content is 45 to 87 mol %.

12. The fuel composition of claim 1, wherein at least 85 mol % of the terminal unsaturation is selected from the vinylidene, one or more the tri-substituted isomers of vinylidene or any combination thereof.

13. The fuel composition of claim 1, wherein the copolymer has an average ethylene run length of less than 2.4.

14. The fuel composition of claim 1, wherein the copolymer has a polydispersity index of less than or equal to 4.

15. The fuel composition of claim 1, wherein the number average molecular weight of the copolymer is less than 3,000 g/mol.

16. The fuel composition of claim 1, wherein the terminal vinylidene and the tri-substituted isomers of the terminal vinylidene of the copolymer have one or more of the following structural Formulas (IV)-(VI): 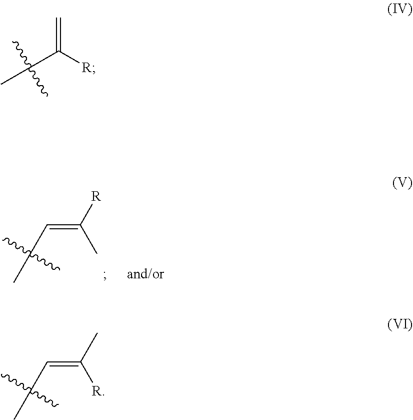
wherein R represents a C₁-C₈ alkyl group and “ [symbol] ” indicates the bond is attached to the remaining portion of the copolymer.

17. The fuel composition of claim 1, wherein the fuel is a diesel fuel.

18. The fuel composition of claim 1, wherein the fuel is a gasoline fuel.

19. A method for operating an internal combustion engine comprising a step of:
combusting the fuel composition of claim 1 in the internal combustion engine during the engine's operation.

20. The method of claim 19, wherein the engine is a diesel engine and the fuel composition is a diesel fuel composition.

21. The method of claim 19, wherein the engine is a gasoline engine and the fuel composition is a gasoline fuel composition.

22. A method for reducing injector valve deposits in a gasoline internal combustion engine, said method comprising the step of combusting a gasoline fuel composition of claim 1 in the gasoline internal combustion engine during the engine's operation.

23. A method for reducing valve sticking in a gasoline internal combustion engine, said method comprising the step of combusting the gasoline fuel composition of claim 21 in the gasoline internal combustion engine during the engine's operation.

24. A method as claimed in claim 23 wherein the gasoline engine is a direct injected gasoline engine.

25. A method for stabilizing a diesel fuel composition, said method comprising the step of combining with said diesel fuel composition an additive composition including the fuel additive of claim 1.

26. A method for reducing injector nozzle fouling in a diesel internal combustion engine, said method comprising the step of combusting the diesel fuel composition of claim 20 in the diesel internal combustion engine during the engine's operation.
